(19) United States
(12) Patent Application Publication
(10) Pub. No.: US 2013/0271757 A1
(43) Pub. Date: Oct. 17, 2013

(54) REAL-TIME, THREE-DIMENSIONAL OPTICAL COHERENCE TOMOGRAPNY SYSTEM

(71) Applicants: Jin Ung Kang, Ellicott City, MD (US); Kang Zhang, Baltimore, MD (US)

(72) Inventors: Jin Ung Kang, Ellicott City, MD (US); Kang Zhang, Baltimore, MD (US)

(73) Assignee: The John Hopkins University, Baltimore, MD (US)

(21) Appl. No.: 13/997,114

(22) PCT Filed: Dec. 21, 2011
(86) PCT No.: PCT/US11/66603

§ 371 Date: Jun. 21, 2013

Related U.S. Application Data
(60) Provisional application No. 61/426,399, filed on Dec. 22, 2010.
(60) Provisional application No. 61/426,403, filed on Dec. 22, 2010.
(60) Provisional application No. 61/426,406, filed on Dec. 22, 2010.

(51) Int. Cl. G01B 9/02

(52) U.S. Cl. CPC G01B 9/02091
USPC 356/300; 356/479

(57) ABSTRACT

A real-time, three-dimensional optical coherence tomography system includes an optical interferometer configured to illuminate a target with light and to receive light returned from the target; an optical detection system arranged in an optical path of light from the optical interferometer after being returned from the target, the optical detection system providing output data signals; and a data processing system adapted to communicate with the optical detection system to receive the output data signals. The data processing system includes a parallel processor configured to process the output data signals to provide real-time, three-dimensional optical coherence tomography images of the target.

### CROSS-REFERENCE OF RELATED APPLICATION

This application claims priority to U.S. Provisional Application No. 61/426,399; 61/426,403; and 61/426,406 each of which were filed Dec. 22, 2010, the entire contents of which are hereby incorporated by reference.

This invention was made with Government support of Grant No. R21 1R21NS0633131-01A1, awarded by the Department of Health and Human Services, The National Institutes of Health (NIH). The U.S. Government has certain rights in this invention.

### BACKGROUND

1. Field of Invention

The field of the currently claimed embodiments of this invention relates to optical coherence tomography systems; and more particularly to real-time, three-dimensional optical coherence tomography systems.

2. Discussion of Related Art

Optical coherence tomography (OCT) has been viewed as an “optical analogy” of ultrasound sonogram (US) imaging since its invention in early 1990's (D. Huang, E. A. Swanson, C. P. Lin, J. S. Schuman, W. G. Stinson, W. Chang, M. R. Hee, T. Flotte, K. Gregory, C. A. Puliafito, and J. G. Fujimoto, “Optical coherence tomography,” Science, vol. 254, pp. 1178-1181, 1991). Compared to the conventional image-guided interventions (IGI) using modalities such as MRI, X-ray CT and US (T. Peters and K. Cleary, Image-Guided Interventions: Technology and Applications, Springer, 2008), OCT has much higher spatial resolution and therefore possesses great potential for applications in a wide range of microsurgeries, such as vitreo-retinal surgery, neurological surgery and otolaryngologic surgery.

As early as the late 1990's, interventional OCT for surgical guidance using time domain OCT (TD-OCT) at a slow imaging speed of hundreds of A-scans/s has been demonstrated (S. A. Boppart, B. E. Bouma, C. Pitris, G. J. Tearney, J. F. Southern, M. E. Brezinski, J. G. Fujimoto, “Intraoperative assessment of microsurgery with three-dimensional optical coherence tomography,” Radiology, vol. 208, pp. 81-86, 1998). Thanks to the technological breakthroughs in Fourier domain OCT (FD-OCT) during the last decade, ultrahigh-speed OCT is now available at >100,000 A-scan/s. For example, see the following:
B. Potsaid, I. Gorczynska, V. J. Srinivasan, Y. Chen, J. Jiang, A. Cable, and J. G. Fujimoto, “Ultrahigh speed Spectral/Fourier domain OCT ophthalmic imaging at 70,000 to 312,500 axial scans per second,” Opt. Express, vol. 16, pp. 15149-15169, 2008.
R. Huber, D. C. Adler, and J. G. Fujimoto, “Buffered Fourier domain mode locking: unidirectional swept laser sources for optical coherence tomography imaging at 370,000 lines/s,” Opt. Lett., vol. 31, pp. 2975-2977, 2006.
W-Y. Oh, B. J. Vakoc, M. Shishkov, G. J. Tearney, and B. E. Bouma, “>400 kHz repetition rate wavelength-swept laser and application to high-speed optical frequency domain imaging,” Opt. Lett., vol. 35, pp. 2919-2921, 2010.
B. Potsaid, B. Baumann, D. Huang, S. Barry, A. E. Cable, J. S. Schuman, J. S. Duker, and J. G. Fujimoto, “Ultrahigh speed 1050 nm swept source/Fourier domain OCT retinal and anterior segment imaging at 100,000 to 400,000 axial scans per second,” Opt. Express, vol. 18, pp. 20029-20048, 2010.
W. Wieser, B. R. Biedermann, T. Klein, C. M. Eigenwillig, and R. Huber, “Multi-Megahertz OCT: High quality 3D imaging at 20 million A-scans and 4.5 GVoxels per second,” Opt. Express, vol. 18, pp. 14685-14704, 2010.
T. Klein, W. Wieser, C. M. Eigenwillig, B. R. Biedermann, and R. Huber, “Megahertz OCT for ultrawide-field retinal imaging with a 1050 nm Fourier domain mode-locked laser,” Opt. Express, vol. 19, pp. 3044-3062, 2011.

For a spectrometer-based SD-OCT, an ultrahigh speed CMOS line scan camera based system has achieved up to 312,500 line/s in 2008 (Potsaid et al.); while for a swept laser type OCT, >20,000,000 line/s rate was achieved by multi-channel FD-OCT using a Fourier Domain Mode Locking (FDML) laser in 2010 (Wieser et al.).

For a clinical interventional imaging system, high-speed image acquisition, reconstruction and visualization are all essential. While the acquisition speed has satisfied the real-time multi-dimensional imaging requirement, current FD-OCT systems generally suffers from shortcomings in the last two stages:

(1) Slow image reconstruction of A-scans which is generally computational intensive due to the huge volume of numerical interpolation and fast Fourier transform (FFT) involved. Moreover, for the complex-conjugate-free full-range FD-OCT, a widely used phase-modulation approach requires a modified Hilbert transform (MHT) [10-15], which is even more time-consuming. See, for example:
Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt., vol. 45, pp. 1861-1865, 2006.
B. Baumann, M. Pircher, E. Götzinger and C. K. Hitzenberger, “Full range complex spectral domain optical coherence tomography without additional phase shifters,” Opt. Express, vol. 15, pp. 13375-13387 2007.
L. An and R. K. Wang, “Use of a scanner to modulate spatial interferograms for in vivo full-range Fourier-domain optical coherence tomography,” Opt. Lett., vol. 32, pp. 3423-3425, 2007.
S. Vergnole, G. Lamouche, and M. L. Dufour, “Artifact removal in Fourier-domain optical coherence tomography with a piezoelectric fiber stretcher,” Opt. Lett., vol. 33, pp. 732-734, 2008.
R. A. Leitgeb, R. Michaely, T. Lasser, and S. C. Sekhar, “Complex ambiguity-free Fourier domain optical coherence tomography through transverse scanning,” Opt. Lett., vol. 32, pp. 3453-3455, 2007.
S. Makita, T. Fabritius, and Y. Yasuno, “Full-range, high-speed, high-resolution 1-μm spectral-domain optical coherence tomography using BM-scan for volumetric imaging of the human posterior eye,” Opt. Express, vol. 16, pp. 8406-8420, 2008.

(2) Slow comprehensively visualization of a 3D OCT data set using a volume rendering technique such as ray-casting (M. Levoy, “Display of Surfaces from Volume Data,” IEEE Comp. Graph. & Appl., vol. 8, pp. 29-37, 1988) adds a heavy computation load. Therefore, most high-speed OCT systems usually cannot operate in real time and typically operate in the “post-processing” mode, which limits their applications.

Current real-time video-rate OCT display is generally limited to 2D (B-scan) images. The most common way of dealing with huge amounts of volumetric data (C-scan) is to “capture and save” and then perform post-processing at a later time. The post-processing of 3D data usually includes two stages, FD-OCT signal processing and volumetric visualization, both of which are heavy-duty computing tasks due to the huge data size. Therefore, real-time signal processing and volumetric visualization has two bottlenecks for an ultra-high speed FD-OCT system that could be a useful system for clinical applications such as surgical intervention and instrument guidance, which usually requires a real-time 4D imaging capability.

To overcome the signal processing bottleneck, several solutions have recently been proposed and demonstrated: Multi-CPU parallel processing has been implemented and achieved 80,000 line/s processing rate on nonlinear-k system (G. Liu, J. Zhang, L. Yu, T. Xie, and Z. Chen, “Real-time polarization-sensitive optical coherence tomography data processing with parallel computing,” Appl. Opt. 48, 6365-6370 (2009)) and 207,000 line/s on linear-k system for 1024-OCT (J. Probst, P. Koch, and G. Huttmann, “Real-time 3D rendering of optical coherence tomography volumetric data,” Proc. SPIE 7372, 73720Q (2009)); A linear-k Fourier-domain mode-locked laser (FDML) with direct hardware frequency demodulation method enabled real-time en face image by yielding the analytic reflectance signal from one depth for each axial scan (B. R. Biedermann, W. Wieser, C. M. Eigenwillig, G. Palte, D. C. Adler, V. J. Srinivasan, J. G. Fujimoto, and R. Huber, “Real time en face Fourier-domain optical coherence tomography with direct hardware frequency demodulation,” Opt. Lett. 33, 2556-2558 (2008)). More recently, a graphics processing unit (GPU) has been utilized for processing FD-OCT data (Y. Watanabe and T. Itagaki, “Real-time display on Fourier domain optical coherence tomography system using a graphics processing unit,” J. Biomed. Opt. 14, 060506 (2009)) using linear-k spectrometer. However, the methods cited above are limited to highly-special linear-k FD-OCT systems to avoid interpolation for λ-to-k spectral re-sampling. Therefore, they are not applicable to the majority of nonlinear-k FD-OCT systems. Moreover, a linear-k spectrometer is not completely linear over the whole spectrum range (Watanabe et al.; Z. Hu and A. M. Rollins, “Fourier domain optical coherence tomography with a linear-in-wavenumber spectrometer,” Opt. Lett. 32, 3525-3527 (2007)) so re-sampling would still be required for a wide spectrum range which is essential for achieving ultra-high axial resolution.

For the volumetric visualization issue, multiple 2D slice extraction and co-registration is the simplest approach, while volume rendering offers a more comprehensive spatial view of the whole 3D data set, which is not immediately available from 2D slices. However, volume rendering such as ray-casting is usually very time-consuming for CPUs. There thus remains a need for OCT systems.

### SUMMARY

A real-time, three-dimensional optical coherence tomography system according to some embodiments of the current invention includes an optical interferometer configured to illuminate a target with light and to receive light returned from the target; an optical detection system arranged in an optical path of light from the optical interferometer after being returned from the target, the optical detection system providing output data signals; and a data processing system adapted to communicate with the optical detection system to receive the output data signals. The data processing system includes a parallel processor configured to process the output data signals to provide real-time, three-dimensional optical coherence tomography images of the target.

### BRIEF DESCRIPTION OF THE DRAWINGS

Further objectives and advantages will become apparent from a consideration of the description, drawings, and examples.

FIG. 1 is a schematic illustration of a real-time, three-dimensional optical coherence tomography system according to an embodiment of the current invention. This embodiment includes; CMOS, CMOS line scan camera; L, spectrometer lens; G, reflective grating; C1, C2, achromatic collimators; C, 50:50 broadband fiber coupler; CL, camera link cable; COMP, host computer; GPU, graphics processing unit; PCIE-X16, PCI Express x16 2.0 interface; MON, Monitor; GVS, galvanometer mirror pairs; R1, R2, relay lens; SL, scanning lens; RG, reference glass; SP, Sample.

FIG. 2 is a schematic illustration of CPU-GPU hybrid system architecture according to an embodiment of the current invention.

FIG. 3 is a flowchart of parallelized LSI according to an embodiment of the current invention. Darkly shaded blocks: memory for pre-stored data; Lightly shaded blocks: memory for real-timely refreshed data.

FIG. 4A is a schematic illustration of a ray-casting CPU-GPU hybrid architecture according to an embodiment of the current invention.

FIG. 4B is a flowchart of interactive volume rendering by GPU according to an embodiment of the current invention.

FIG. 5A shows data for GPU processing time versus one-batch A-scan number according to an embodiment of the current invention.

FIG. 5B shows data for GPU processing line rate versus one-batch A-scan number according to an embodiment of the current invention.

FIGS. 6A and 6B show system sensitivity roll-off according to an embodiment of the current invention for: (a) 1024-OCT; (b) 2048-OCT.

FIGS. 7A and 7B show B-scan images of an infrared sensing card according to an embodiment of the current invention for: (a) 1024-OCT, 10,000 A-scan/frame, 12.8 frame/s; (b) 2048-OCT, 10,000 A-scan/frame, 7.0 frame/s. The scale bars represent 250 μm in both dimensions.

FIGS. 8A-8E show En face slices reconstructed from real-timely acquired and processed volumetric data according to an embodiment of the current invention for: (a) 250×160×512 voxels; (b) from the same volume as (a) but 25 μm deeper; (c) 250×80×512 voxels; (d) from the same volume as (c) but 25 μm deeper; (e) 125×80×512 voxels; (f) from the same volume as (e) but 25 μm deeper. The scale bar represents 100 μm for all images

FIGS. 9A-9C show (a) (Media 1) The dynamic 3D OCT movie of a piece of sugar-shell coated chocolate; (b) sugar-shell top truncated by the X-Y plane, inner structure visible; and (c) A five-layer phantom, according to an embodiment of the current invention.

FIGS. 10A-10C show In vivo real-time 3D imaging of a human fingertip according to an embodiment of the current invention for: (a) (Media 2) Skin and fingernail connection; (b) (Media 3) Fingerprint, side-view with “L” volume rendering frame; (c) (Media 4) Fingerprint, top-view.

FIG. 11A-11F show (Media 5) Multiple 2D frames real-time rendering from the same 3D data set as in FIGS. 10A-10C, with different modelview matrix according to an embodiment of the current invention.

FIG. 12 is a schematic illustration of a real-time, three-dimensional optical coherence tomography system according to an embodiment of the current invention. This embodiment includes: CMOS, CMOS line scan camera; L, spectrometer lens; G, grating; C1, C2, C3, achromatic collimators; C, 50:50 broadband fiber coupler; CL, camera link cable; COMP, host computer; GPU, graphics processing unit; PCIE, PCI Express x16 interface; MON, Monitor; GV, galvanometer (only the first galvanometer is illustrated for simplicity); SL, scanning lens; DCL, dispersion compensation lens; M, reference mirror; PC, polarization controller; SP, Sample.

FIG. 13 is a processing flowchart according to an embodiment of the current invention for GPU-NUDFT based FD-OCT: CL, Camera Link; FG, frame grabber; HM, host memory; GM, graphics global memory; DC, DC removal; MT, matrix transpose; FFT-x, Fast Fourier transform in x direction; IFFT-x, inverse Fast Fourier transform in x direction; BPF-x, band pass filter in x direction; Log, logarithmical scaling. The solid arrows describe the main data stream and the hollow arrows indicate the internal data flow of the GPU. The dashed arrows indicate the direction of inter-thread triggering. The hollow dashed arrow denotes standard FD-OCT without the Hilbert transform in x direction. Darkly shaded blocks: memory for pre-stored data; Lightly shaded blocks: memory for real-timely refreshed data.

FIG. 14 illustrates convolution with a Gaussian interpolation kernel on a uniform grid when R=2, Mₛₚ=2 according to an embodiment of the current invention.

FIG. 15 is a processing flowchart according to an embodiment of the current invention for GPU-NUFFT based FD-OCT: CL, Camera Link; FG, frame grabber; HM, host memory; GM, graphics global memory; DC, DC removal; MT, matrix transpose; CON; convolution with Gaussian kernel; FFT-x, Fast Fourier transform in x direction; IFFT-x, inverse Fast Fourier transform in x direction; BPF-x, band pass filter in x direction; FFT-kᵣ, FFT in kᵣ direction; TRUC, truncation of redundant data in kᵣ direction; DECON, deconvolution with Gaussian kernel; Log, logarithmical scaling. The dashed arrows indicate the direction of inter-thread triggering. The solid arrows describe the main data stream and the hollow arrows indicate the internal data flow of the GPU. The hollow dashed arrow denotes standard FD-OCT without the Hilbert transform in x direction.

FIGS. 16A-16D show benchmark line rate test of different FD-OCT processing methods. (a) 1024-pixel FD-OCT; (b) 2048-pxiel FD-OCT; (c) 1024-pixel NUFFT-C with different frame size; (d) 2048-pixel NUFFT-C with different frame size; Both the peak internal processing line rate and the reduced line rate considering the data transfer bandwidth of PCIE x16 interface are listed.

FIGS. 17A-17H show point spread function and sensitivity roll-off of different processing methods: (a) LIFFT; (b) CIFFT; (c) NUDFT; (d) NUFFT; (e) Comparison of PSF at certain image depth using different processing; (f) Comparison of sensitivity roll-off using different processing methods; (g) A-scan FWHM with depth; (h) Performance of NUFFT with different Mₛₚ values.

FIGS. 18A-18I show real-time images of a multilayered phantom using different processing methods, where the bars represent 1 mm in both dimensions for all images: (a) LIFFT (Media 1, 29.8 fps); (b) CIFFT (Media 2, 29.8 fps); (c) NUDFT (Media 3, 9.3 fps); (d) NUFFT (Media 4, 29.8 fps). All images are originally 4096 pixel (lateral)×1024 pixel (axial) and rescaled to 1024 pixel (lateral)×512 pixel (axial) for display on the monitor. (e)˜(h): Magnified view corresponding to the boxed area in (a)˜(d). ZDL: zero delay line. The dark arrows in (a) and (b) indicate the ghost image due to the presence of side-lobes of the reflective surface at a large image depth relative to ZDL. The vertical lines correspond to the A-scans extracted from the same lateral position of each image, shown collectively in (i). The side-lobes of LIFFT/CIFFT are indicated by the arrow in (i).

FIGS. 19A-19F show real-time C-FD-OCT images using GPU-NUFFT, where the bars represent 1 mm in both dimensions for all images: (a) (Media 5) Finger tip, (coronal). (b) (Media 6) Finger palm (coronal). (c)˜(d) (Media 7) Finger nail fold (coronal); (e)˜(f) (Media 8, 9) Finger nail (sagittal). SD, sweat duct; SC, stratum corneum; SS, stratum spinosum; NP, nail plate; NB, nail bed; NR, nail root; E, epidermis; D, dermis.

FIGS. 20A and 20B is a schematic illustration of a real-time, three-dimensional optical coherence tomography system according to an embodiment of the current invention. This embodiment includes: (a) System configuration: CMOS, CMOS line scan camera; L, spectrometer lens; G, grating; C1, C2, C3, achromatic collimators; C, 50:50 broadband fiber coupler; CL, camera link cable; COMP, host computer; GPU, graphics processing unit; PCIE, PCI Express x16 2.0 interface; MON, Monitor; GV, galvanometer; SL, scanning lens; DCL, dispersion compensation lens; M, reference mirror; PC, polarization controller; SP, Sample. (b) GPU processing flowchart: FG, frame grabber; HM, host memory; GM, graphics memory; LSI, linear spline interpolation; FFT-x, Fast Fourier transform in x direction; IFFT-x, inverse Fast Fourier transform in x direction; FFT-k, Fast Fourier transform in k direction; BPF-x, band pass filter in x direction.

FIGS. 21A-21F show real-time complex OCT images, where the bars represent 1 mm in both dimensions for all images: (a) Five-layer polymer phantom. ZDL, zero-delay line; (b) Finger print (coronal); (c) Finger print (sagittal). SD, sweat duct; SC, stratum corneum; SS, stratum spinosum; (d) Finger nail (coronal); (e)˜(f) Finger nail (sagittal). NP, nail plate; NB, nail bed; NG, nail groove; NR, nail root; NF nail folding; E, epidermis; D, dermis.

FIG. 22 is a schematic illustration of a real-time, three-dimensional optical coherence tomography system according to an embodiment of the current invention. This embodiment includes: CMOS, CMOS line scan camera; G, grating; L1, L2, L3, L4 achromatic collimators; C, 50:50 broadband fiber coupler; CL, camera link cable; CTRL, galvanometer control signal; GVS, galvanometer pairs (only the first galvanometer is illustrated for simplicity); SL, scanning lens; DCL, dispersion compensation lens; M, reference mirror; PC, polarization controller.

FIG. 23 is a signal processing flow chart of the dual-GPUs architecture of the embodiment of FIG. 22. Dashed arrows, thread triggering; Solid arrows, main data stream; Hollow arrows, internal data flow of the GPU. Here the graphics memory refers to global memory.

FIGS. 24A-24D provide results for optical performance of the system of FIGS. 22 and 23: (a) and (b), PSFs processed by linear interpolation with FFT, arrows indicate the side lobes of PSFs near positive and negative edges due to interpolation error. (c) and (d), PSFs processed by NUFFT.

FIGS. 25A-25D show (Media 1) In vivo human finger nail fold imaging: (a)˜(d) are rendered from the same 3D data set with different view angles. The arrows with dots on each 2D frame correspond to the same edges/vertexes of the rendering volume frame. Volume size: 256(Y)×100(X)×1024(Z) voxels/3.5 mm (Y)×3.5 mm (X)×3 mm (Z).

FIGS. 26A-26D show (Media 2) Real-time 4D full-range FD-OCT guided micro-manipulation using a phantom model and a vitreoretinal surgical forceps. The arrows with dots on each 2D frame correspond to the same edges/vertexes of the rendering volume frame. Volume size: 256(Y)×100(X)×1024(Z) voxels/3.5 mm (Y)×3.5 mm (X)×3 mm (Z).

FIGS. 27A-27E show components of a real-time, three-dimensional optical coherence tomography system according to an embodiment of the current invention. (a) Probe design. (b) ZEMAX simulation of lens set. (c) ZEMAX simulation of spot size. (d) Fiber scanning of 1 mm. (e) A probe prototype.

FIG. 28 is a schematic illustration of a real-time, three-dimensional optical coherence tomography system according to an embodiment of the current invention that can incorporate the components of FIGS. 27A-27E. This embodiment includes: CCD, CCD line scan camera; G, grating; L1, L2, L3, achromatic lenses; CL, camera link cable; COMP, host computer; C, 50:50 broadband fiber coupler; PC, polarization controller; GV, galvanometer with reference mirror; MT, magnetic transducer; SMF, single-mode fiber; SL1, SL2, scanning lens; SP, sample; FG, function generator.

FIG. 29 shows positions of probe and reference during the phase modulation for an example using the embodiment of FIG. 28.

FIG. 30 is a schematic illustration of a galvanometer-driven reference mirror induced phase modulation that can be used with the embodiment of FIG. 28.

FIGS. 31A-31C show results of a phase modulation test according to an embodiment of the current invention. (a) M-scan frame of 1024 A-scans. (b) Amplitude and (c) Normalized spectral shape of the reference signal for different A-scans within one frame.

FIGS. 32A and 32B show the processing result of an M-scan frame according to an embodiment of the current invention. (a) after step vii. (b) after step viii.

FIG. 33A shows the profile of a single A-scan.

FIG. 33B provides a comparison of dispersion compensated and uncompensated A-scan profiles.

FIGS. 34A and 34B provide images of an IR card without and with phase modulation. The scale bar indicates 500 μm for both directions and the arrow within each image indicates the zero-delay line position.

FIG. 35A provides coronal scans of the finger nail plate; and FIG. 35B provides sagittal scan of finger nail fold region. The scale bar indicates 500 μm for both directions and the arrow within each image indicates the zero-delay line position.

FIG. 36 is a schematic illustration of GPU-accelerated numerical dispersion compensation according to an embodiment of the current invention. Dotted arrows indicate the path for full-range FD-OCT.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “light” as used herein is intended to have a broad meaning that can include both visible and non-visible regions of the electromagnetic spectrum. For example, visible, near infrared, infrared and ultraviolet light are all considered as being within the broad definition of the term “light.” The term “real-time” is intended to mean that the OCT images can be provided to the user during use of the OCT system. In other words, any noticeable time delay between detection and image displaying to a user is sufficiently short for the particular application at hand. In some cases, the time delay can be so short as to be unnoticeable by a user.

Since A-scan OCT signals are acquired and processed independently, the reconstruction of an FD-OCT image is inherently ideal for parallel processing methods, such as multi-core CPU parallelization (G. Liu, J. Zhang, L. Yu, T. Xie, and Z. Chen, “Real-time polarization-sensitive optical coherence tomography data processing with parallel computing,” Appl. Opt., vol. 48, pp. 6365-6370, 2009) and FPGA hardware acceleration (T. E. Ustun, N. V. Iftimia, R. D. Ferguson, and D. X. Hammer, “Real-time processing for Fourier domain optical coherence tomography using a field programmable gate array,” Rev. Sci. Instrum., vol. 79, pp. 114301, 2008; A. E. Desjardins, B. J. Vakoc, M. J. Suter, S. H. Yun, G. J. Tearney, B. E. Bouma, “Real-time FPGA processing for high-speed optical frequency domain imaging,” IEEE Trans. Med. Imaging, vol. 28, pp. 1468-1472, 2009). Recently, cutting-edge general purpose computing on graphics processing units (GPGPU) technology has been gradually utilized for ultra-high speed FD-OCT imaging. See, for example:
Y. Watanabe and T. Itagaki, “Real-time display on Fourier domain optical coherence tomography system using a graphics processing unit,” J. Biomed. Opt., vol. 14, pp. 060506, 2009.
K. Zhang and J. U. Kang, “Real-time 4D signal processing and visualization using graphics processing unit on a regular nonlinear-k Fourier-domain OCT system,” Opt. Express, vol. 18, pp. 11772-11784, 2010.
S. V. Jeught, A. Bradu, and A. G. Podoleanu, “Real-time resampling in Fourier domain optical coherence tomography using a graphics processing unit,” J. Biomed. Opt., vol. 15, pp. 030511, 2010.
Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt., vol. 49, pp. 4756-4762, 2010.
K. Zhang and J. U. Kang, “Graphics processing unit accelerated non-uniform fast Fourier transform for ultrahigh-speed, real-time Fourier-domain OCT,” Opt. Express, 18, pp. 23472-23487, 2010.
K. Zhang and J. U. Kang, “Real-time intraoperative 4D full-range FD-OCT based on the dual graphics processing units architecture for microsurgery guidance,” Biomed. Opt. Express, vol. 2, pp. 764-770, 2011.
J. Rasakanthan, K. Sugden, and P. H. Tomlins, “Processing and rendering of Fourier domain optical coherence tomography images at a line rate over 524 kHz using a graphics processing unit,” J. Biomed. Opt., vol. 16, pp. 020505, 2011.
J. Li, P. Bloch, J. Xu, M. V. Sarunic, and L. Shannon, “Performance and scalability of Fourier domain optical coherence tomography acceleration using graphics processing units,” Appl. Opt., vol. 50, pp. 1832-1838, 2011.
K. Zhang, and J. U. Kang, “Real-time numerical dispersion compensation using graphics processing unit for Fourier-domain optical coherence tomography,” Elect. Lett., vol. 47, pp. 309-310, 2011.

Compared to FPGAs and multi-core processing methods, GPGPU acceleration is more cost-effective in terms of price/performance ratio and convenience of system integration: one or multiple GPUs can be directly integrated into the FD-OCT system in the popular form of a graphics card without requiring any optical modifications. Moreover, as with its original purpose, GPUs are also highly suitable for implementing volume rendering algorithms on reconstructed 3D data sets, which provides a convenient unified solution for both reconstruction and visualization.

Real-time rendering for a large data volume can be provided through the use of a GPU according to some embodiments of the current invention. A complete 3D data set has to be ready prior to any volumetric visualization (B. R. Biedermann, W. Wieser, C. M. Eigenwillig, G. Palte, D. C. Adler, V. J. Srinivasan, J. G. Fujimoto, and R. Huber, “Real time en face Fourier-domain optical coherence tomography with direct hardware frequency demodulation,” Opt. Lett. 33, 2556-2558 (2008)).

Some embodiments of the current invention provide GPU-based, real-time, three-dimensional signal processing and visualization on a regular FD-OCT system with nonlinear k-space. (Since time provides another dimension, this is sometimes also referred to as 4D or real-time 4D, i.e., time plus three spatial dimensions.) An ultra-high-speed, linear spline interpolation (LSI) method for λ-to-k spectral re-sampling can be implemented in a GPU architecture according to some embodiments of the current invention. The complete FD-OCT signal processing, including interpolation, fast Fourier transform (FFT) and post-FFT processing can all be implemented on a GPU according to some embodiments of the current invention. Three-dimensional data sets can be continuously acquired in real time, immediately processed and visualized by either en face slice extraction or ray-casting based volume rendering from 3D texture mapped in graphics memory. For some embodiments, no optical modifications are needed. Such embodiments can be highly cost-effective and can be easily integrated into most ultrahigh speed FD-OCT systems to overcome the 3D data processing and visualization bottlenecks. However, the general concepts of the current invention are not limited to only these particular applications.

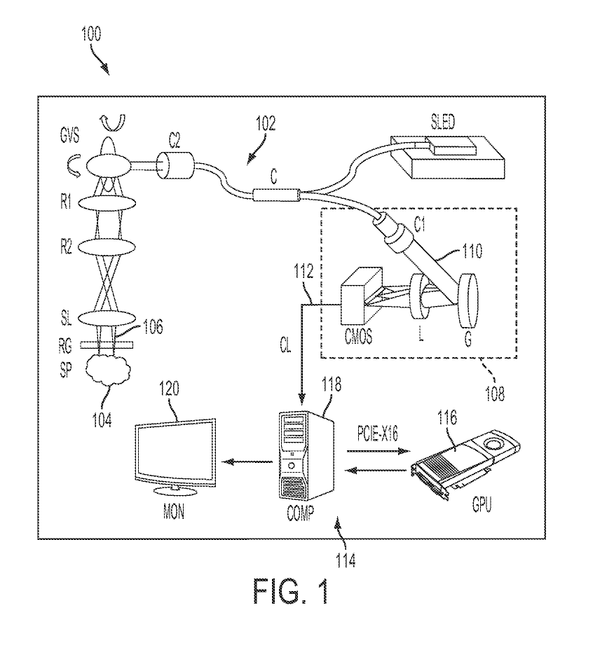

FIG. 1 is a schematic illustration of a real-time, three-dimensional optical coherence tomography system 100 according to an embodiment of the current invention. The real-time, three-dimensional optical coherence tomography system 100 includes an optical interferometer 102 configured to illuminate a target 104 with light 106 and to receive light returned from the target 104. The real-time, three-dimensional optical coherence tomography system 100 also includes an optical detection system 108 arranged in an optical path of light 110 from the optical interferometer 102 after being returned from the target 104. The optical detection system 108 provides output data signals 112. The real-time, three-dimensional optical coherence tomography system 100 further includes a data processing system 114 adapted to communicate with the optical detection system 108 to receive the output data signals 112. The data processing system 114 includes a parallel processor 116 configured to process the output data signals 112 to provide real-time, three-dimensional optical coherence tomography images of the target 104.

FIG. 1 shows an example of the optical interferometer 102 as being a fiber-optic interferometer. Although such interferometers are suitable for many applications of the current invention, the general concepts of the current invention are not limited to only fiber-optic interferometers. In addition, FIG. 1 shows and example of a common path optical interferometer. The invention is not limited to only common path interferometers. Other embodiments will be show in detail below in which an optical interferometer with a reference leg is used. The optical interferometer 102 is not limited to the particular example shown in FIG. 1 and/or the other particular examples below which are shown to facilitate explanation of some concepts of the current invention. In this example, the optical interferometer 102 includes an SLED as a light source. Other light sources that are used with FD-OCT systems can also be used, without limitation. The optical interferometer 102 and the detection system 108 can include further optical components chosen according to the particular application. Some embodiments of the current invention can also include wavelength-swept source based FD-OCT systems.

The parallel processor 116 can be one or more graphics processing units (GPUs) according to an embodiment of the current invention. However, the broad concepts of the current invention are not limited to only embodiments that include GPUs. However, GPUs can provide advantages of cost and speed according to some embodiments of the current invention. In some embodiments, a single GPU can be used. In other embodiments, two GPUs can be used. However, the broad concepts of the current invention are not limited to the use of only one or two GPUs. Three, four or more GPUs can be used in other embodiments.

The parallel processor 116 can be installed on a computer 118, for example, but not limited to, one or more graphics cards. The computer can communicate with the detection system 108 but direct electrical or optical connections, or by wireless connections, for example. real-time, three-dimensional optical coherence tomography system 100 can also include one or more display devices, such as monitor 120, as well as any suitable input or output devices depending on the particular application.

Further additional concepts and embodiments of the current invention will be described by way of the following examples. However, the broad concepts of the current invention are not limited to these particular examples.

### Example 1

### System Configuration and CPU-GPU Hybrid Architecture

FIG. 1 is a schematic illustration of an FD-OCT system used in an example according to an embodiment of the current invention. In this example, a 12-bit CMOS camera (Sprint spL2048-140k, Basler AG, Germany) with 70,000 line/s effective line rate at 2048 pixel mode functions as the detector of the OCT spectrometer. A superluminescence diode (SLED) (λ₀=825 nm, Δλ=70 nm, Superlum, Ireland) was used as the light source, which gives an axial resolution of approximately 5.5 μm in air/4.1 μm in water. The beam scanning was implemented by a pair of high speed galvanometer mirrors driven by a dual channel function generator and synchronized with a high speed frame grabber (PCIe-1429, National Instruments, USA). To simplify alignment issues, the OCT system was configured in a common-path mode, where the reference signal comes from the bottom surface reflection of a glass window placed in between the scanning lens and sample, while the up surface is anti-reflective coated. The common-path structure doesn't require dispersion compensation optics while maintaining a high axial resolution. See, the following:
K. Zhang, W. Wang, J. Han and J. U. Kang, “A surface topology and motion compensation system for microsurgery guidance and intervention based on common-path optical coherence tomography,” IEEE Trans. Biomed. Eng. 56, 2318-2321 (2009).
U. Sharma and Jin U. Kang, “Common-path OCT with side-viewing bare fiber probe for endoscopic OCT,” Rev. Sci. Instrum. 78, 113102 (2007).
K. Zhang, E. Katz, D. H. Kim, J. U. Kang and I. K. Ilev, “A common-path optical coherence tomography guided fiber probe for spatially precise optical nerve stimulation,” Elec. Lett. 46, 118-120 (2010).
U. Sharma, N. M. Fried, and J. U. Kang, “All-fiber common optical coherence tomography: sensitivity optimization and system analysis,” IEEE IEEE J. Sel. Top. Quant., 11, 799-805 (2005).

The lateral resolution is estimated to be 9.5 μm assuming Gaussian beam. An 8-core Dell T7500 workstation was used to obtain and display images, and a GPU (NVIDIA Quadro FX5800 graphics card) with 240 stream processors (1.3 GHz clock rate) and 4 GBytes graphics memory was used to perform OCT signal processing and 3D visualization such as en face slice extraction or volume rendering.

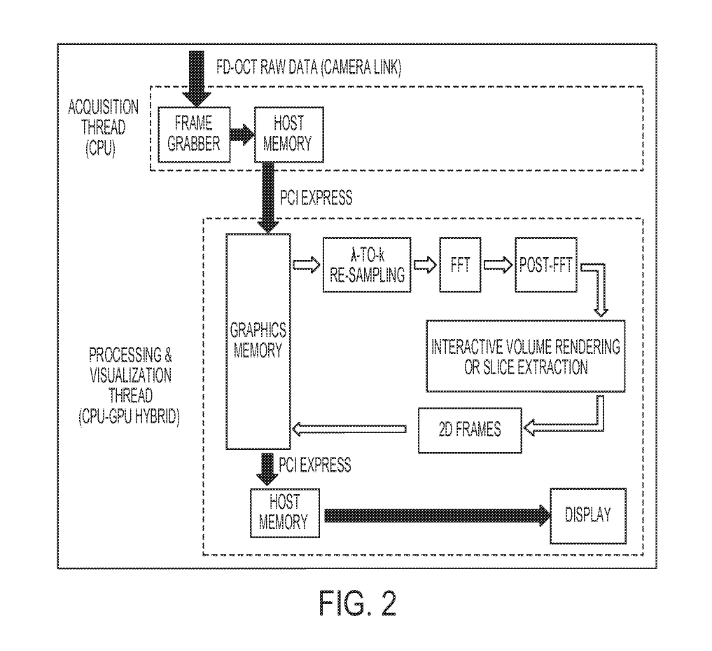

FIG. 2 presents the CPU-GPU hybrid system architecture, where two synchronized threads were used for data acquisition, signal processing and visualization, respectively. The solid arrows describe the main data stream and the hollow arrows indicate the internal data flow of the GPU. In the acquisition thread, a certain number of raw OCT interference spectrums were sequentially grabbed from the CMOS camera, transferred into the frame grabber through camera link cable and then routed into the host computer's memory as a whole data block. In the processing and visualization thread, the grabbed data block was transferred into the graphics card memory through the PCI Express x16 2.0 interface, and then operated for each interferogram in parallel by the 240 graphics stream processors to complete the standard processing including λ-to-k spectral remapping, fast Fourier transform, and post-FFT processing. In the post-FFT processing part, a reference volume acquired and saved in the graphics memory prior to imaging any sample was subtracted by the whole volume before logarithm scaling to remove the DC component as well as the noise and artifact caused by irregular reference signal from the reference plane. The processed 3D data set is then sent to the next stage for visualization by either direct en face slices extraction or being mapped to 3D texture allocated in the graphics memory to perform volume rendering, which will be illustrated in details in the later section. Finally the processed 2D frame is transferred back to the host memory and displayed in the graphical user interface (GUI). The GPU is programmed through NVIDIA's Compute Unified Device Architecture (CUDA) technology (NVIDIA, “NVIDIA CUDA Compute Unified Device Architecture Programming Guide Version 2.3.1,” (2009)). The FFT operation is implemented by the CUFFT library (NVIDIA, “NVIDIA CUDA CUFFT Library Version 2.3,” (2009)). Since currently there is no suitable function in CUDA library for λ-to-k spectral re-sampling, here we propose a GPU accelerated linear spline interpolation (LSI) method as follows:

Start from the LSI equation:

$${S}^{′} [ j ] = S [ i ] + \frac{S [ i + 1 ] - S [ i ]}{k [ i + 1 ] - k [ i ]} ( {k}^{′} [ j ] - k [ i ] ) . \qquad ( 1.1 )$$

where k[n]=2π/λ[n] is the nonlinear k-space value series and λ[n] is the calibrated wavelength values of the FD-OCT system. S[n] is the spectral intensity series corresponding to k[n]. k′[n] is the linear k-space series covering the same frequency range as k[n]. Linear spline interpolation requires a proper interval [k[i], k[i+1]] for each k′[j], that is:

k[i]<k′[j]<k[i+1]. (1.2)

Let a series E[n] present the lower ends for each element of k[n], then Eq. (1.1) can be written as:

$${S}^{′} [ j ] = S [ E [ i ] ] + \frac{S [ E [ j ] + 1 ] - S [ E [ j ] ]}{k [ E [ j ] + 1 ] - k [ E [ j ] ]} ( {k}^{′} [ j ] - k [ E [ j ] ] ) . \qquad ( 1.3 )$$

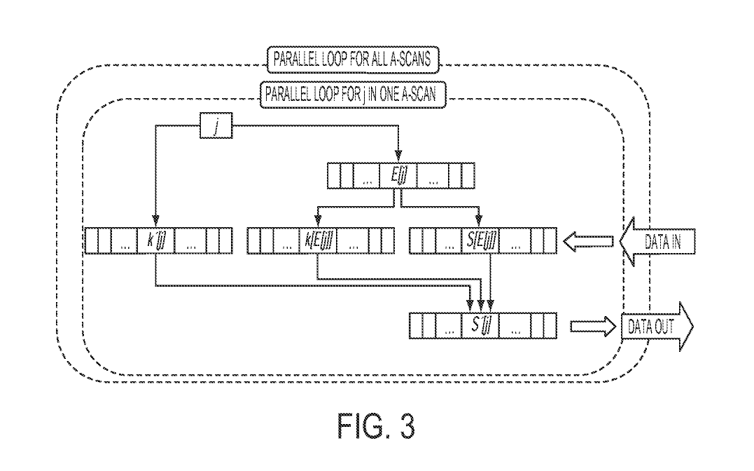

E[n] can be easily obtained before interpolation by comparing k[n] and k′[n]. From Eq. (1.3), one would notice that S′[j] is independent of other values in the series S′[n], therefore this LSI algorithm is highly suitable for the parallel computation. FIG. 3 shows the flowchart of parallelized LSI, where the parallel loops are distributed onto the GPU's 240 stream processors. The values of E[n], k[n] and k′[n] are all stored in graphics global memory prior to interpolation, while the S[1] and S′[n] are allocated in real-time refreshed memory blocks.

### Interactive Volume Rendering by Ray-Casting

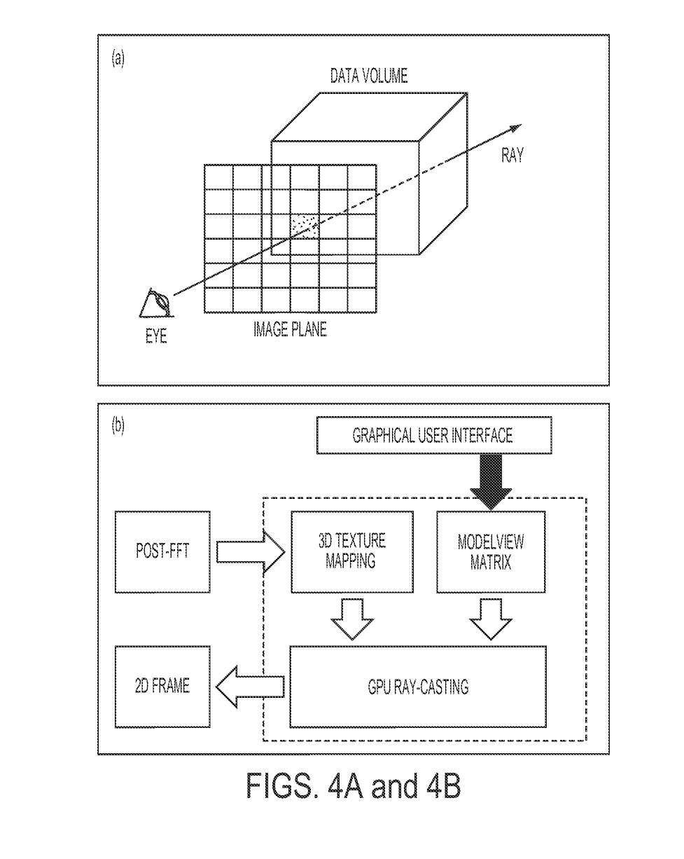

Volume rendering is a numeric simulation of the eye's physical vision process in the real world, which provides better presentation of the entire 3D image data than the 2D slice extraction (J. Kruger and R. Westermann, “Acceleration techniques for GPU-based volume rendering,” in Proceedings of the 14th IEEE Visualization Conference (VIS'03) (IEEE Computer Society, Washington, D.C., 2003), pp. 287-292; A. Kaufman and K. Mueller, “Overview of Volume Rendering,” in The Visualization Handbook, C. Johnson and C. Hansen, ed. (Academic Press, 2005); M. Levoy, “Display of Surfaces from Volume Data,” IEEE Comp. Graph. and. Appl. 8, 29-37 (1988)). Ray-casting is the simplest and most straightforward method for volume rendering, shown as FIG. 4A. An imaging plane is defined between the observer's eye and the data volume, and each pixel of the imaging plane is the integration along the specific eye ray through the pixel, which can be presented by the following recursive back-to-front compositing equations (Levoy, id.):

C(λ)ₒᵤₜ(uⱼ)=C(λ)ᵢₙ(uⱼ)*(1−α(xᵢ))+C(λ)(xᵢ)*α(xᵢ). (1.4)

αₒᵤₜ(uⱼ)=αᵢₙ(uⱼ)*(1−α(xᵢ))+α(xᵢ). (1.5)

where C(λ)(xᵢ) and α(xᵢ) stands for the color and opacity values of a single voxel at the spatial position xᵢ. C(λ)ₒᵤₜ(uⱼ), αₒᵤₜ(uⱼ), C(λ)ᵢₙ(uⱼ) and αᵢₙ(uⱼ) are the color and opacity values on a particular eye ray in, and out of this voxel. The eye ray corresponds to a pixel position uᵢ on the image plane, and voxels along the ray will be taken into account for color and opacity accumulation.

The principle of ray-casting demands heavy computing duty, so in general real-time volume rendering requires the use of hardware acceleration devices such as a GPU. FIG. 4B illustrates the details of the interactive volume rendering portion for FIG. 2. After post-FFT processing, the 3D data set is mapped into 3D texture, a pre-allocated read-only section on the graphics memory. A certain modelview matrix is obtained through the GUI functions to determine the relative virtual position between data volume and imaging plane (D. Shreiner, M. Woo, J. Neider and T. Davis, OpenGL Programming Guide, Sixth Edition (Addison-Wesley Professional, 2007), chap. 3). Then the GPU performs a ray-casting method to render the 2D frame from the 3D texture according to the modelview matrix. To insure compatibility with the NI-IMAQ Win32 API and simplify the software structure, we have developed and implemented the ray-casting function using the CUDA language and the 2D frames are finally displayed using an NI-IMAQ window.

### OCT Data Processing Capability

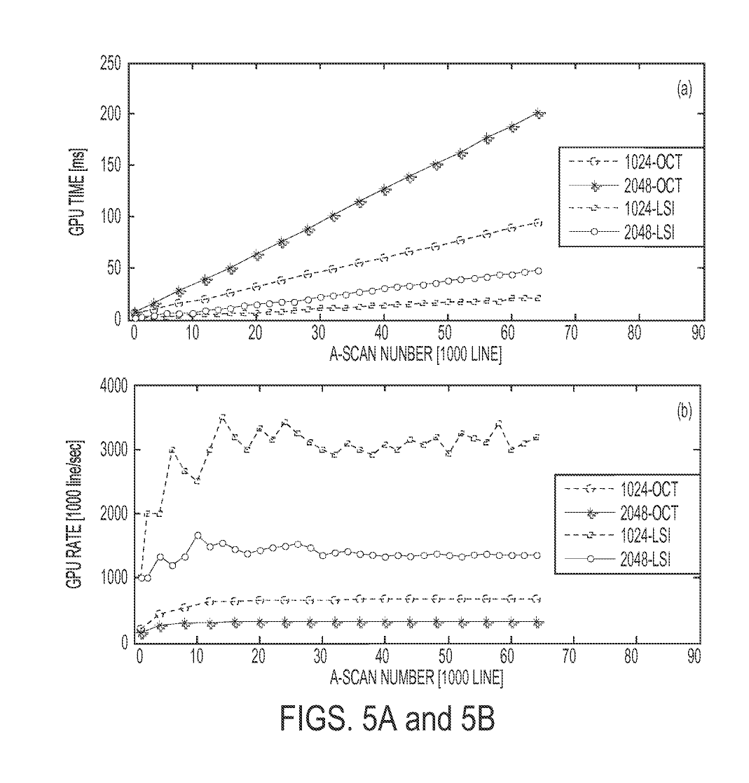

To test the GPU's OCT data processing ability, we processed a series of large numbers of A-scan lines in one batch. The complete processing time is recorded in milliseconds from the interval between the data transfer-in (host memory to graphics memory) and data transfer-out (graphics memory to host memory), and the time for interpolation is also recorded. Here both 2048-pixel and 1024-pixel OCT modes were tested and the 1024-pixel mode was enabled by the CMOS camera's area-of-interest (AOI) output feature. The processing time versus one-batch line number is shown as FIG. 5A. The corresponding processing line rate can be easily calculated and shown in FIG. 5B. The interpolation speed averages at >3,000,000 line/s for 1024-OCT and >1,400,000 line/s for 2048-OCT. The complete processing speed goes up to 320,000 line/s for the 2048-OCT and 680,000 line/s for the 1024-OCT. This is equivalent to approximately 1 GByte/s processing bandwidth at 12 bit/pixel. Since commonly used high-end frame grabbers (i.e. PCIe-1429) have an acquisition bandwidth limit of 680 MBytes/s, the GPU processing should be able to process all of the OCT data in real-time. As one can see, the processing bandwidth decreases in the case of smaller A-scan batch numbers (1000-10,000) due to the GPU's hardware acceleration feature but it is still above 140,000 line/s for 2048-pixel and above 200,000 line/s for 1024-pixel, which is adequate enough to over-speed the camera and also leaves enough time for volume rendering.

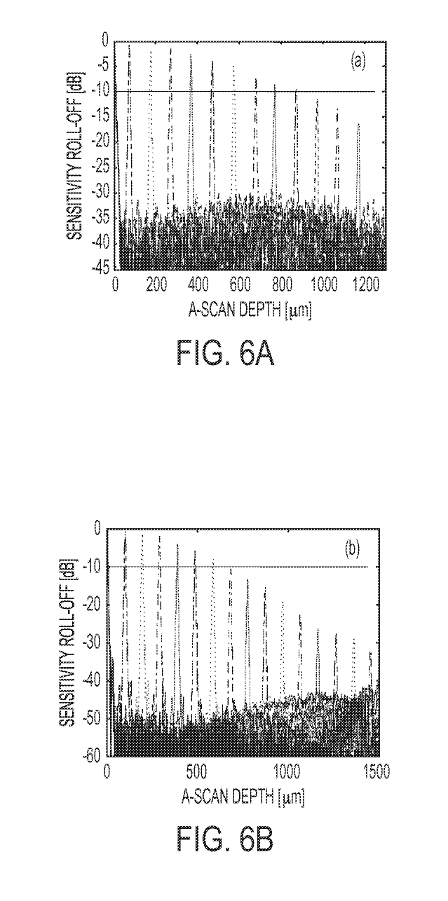

FIG. 6 shows the system sensitivity roll-off at both 1024-OCT and 2048-OCT modes, where the A-scans are processed by GPU based LSI and FFT. As one can see, the background noise increases with imaging depth due to the error of linear interpolation, and this issue can be solved by a more complex zero-filling method (C. Dorrer, N. Belabas, J. Likforman, and M. Joffre, “Spectral resolution and sampling issues in Fourier-transform spectral interferometry,” J. Opt. Soc. Am. B 17, 1795-1802 (2000), which will be implemented on GPU in our future work.

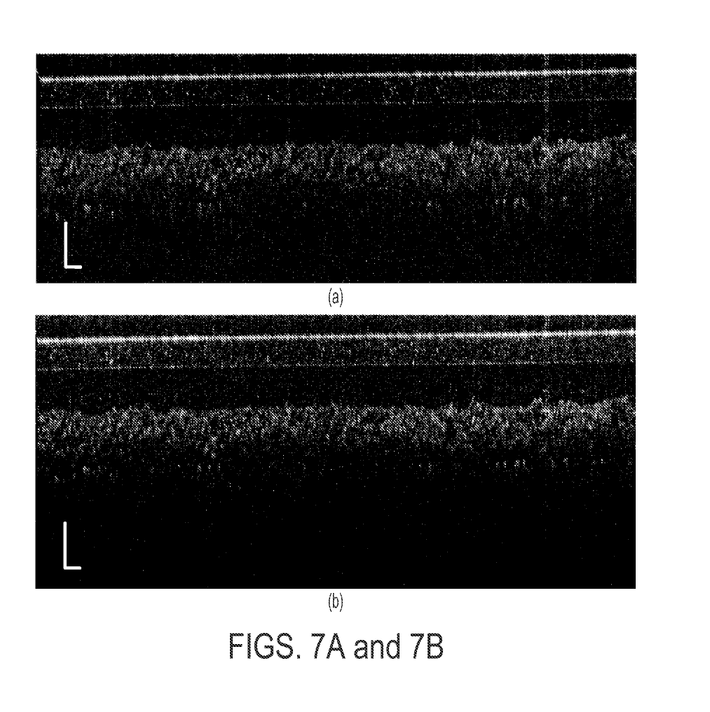

We then tested the actual imaging speed by performing the real-time acquisition and display of 2-D B-scan images. The target used is an infrared sensing card, as in FIG. 7. Each frame consists of 10,000 A-scans and we got 12.8 frame/s for 1024-OCT (minimum line period=7.8 μs) and 7.0 frame/s for 2048-OCT (minimum line period=14.2 μs), corresponding to 128,000 and 70,000 A-scan/s respectively, which is limited by the CMOS camera's acquisition speed.

To demonstrate the higher acquisition speed case and evaluate the possible bus and memory contention issue, for each frame the raw data transferring-in and processing were repeated for 4 times within each frame period, while achieving the same frame rate for both OCT modes. Therefore the minimum effective processing speeds of 512,000 A-scan/s for 1024-OCT and 280,000 A-scan/s for 2048-OCT can be expected. These speeds represent more than double the currently highest acquisition speed using a CMOS camera, which is 215,000 A-scan/s for 1024-OCT (J. Probst, P. Koch, and G. Huttmann, “Real-time 3D rendering of optical coherence tomography volumetric data,” Proc. SPIE 7372, 73720Q (2009)) and 135,000 A-scan/s for 2048-OCT (I. Grulkowski, M. Gora, M. Szkulmowski, I. Gorczynska, D. Szlag, S. Marcos, A. Kowalczyk, and M. Wojtkowski, “Anterior segment imaging with Spectral OCT system using a high-speed CMOS camera,” Opt. Express 17, 4842-4858 (2009), http://www.opticsinfobase.org/oe/abstract.cfm?uri=oe-17-6-4842).

### Volumetric Visualization by En Face Slicing

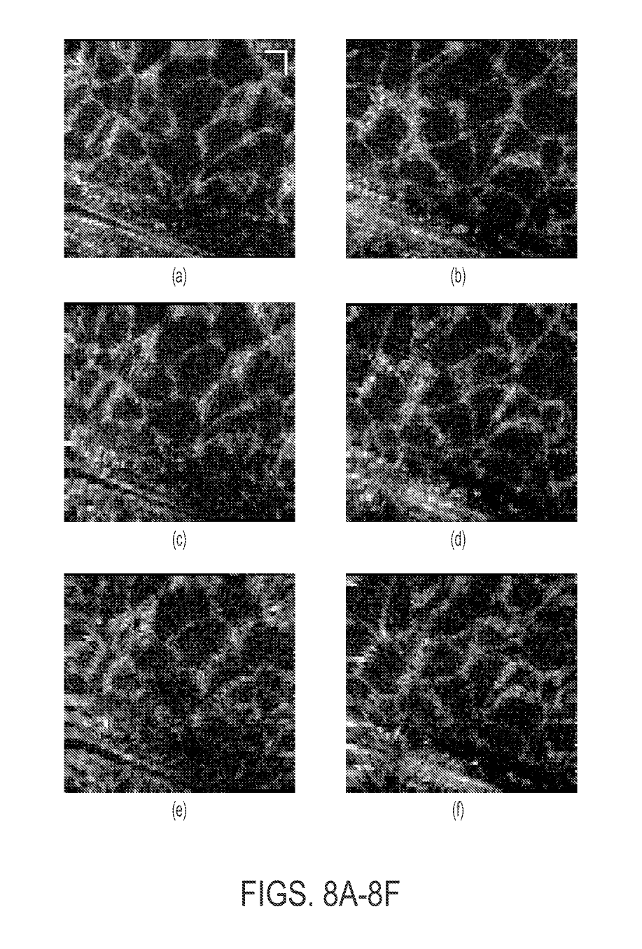

We further tested the real-time volumetric data processing and en face image reconstruction by running the OCT at 1024-pixel mode. The line scan rate was set to 100,000 line/second for the convenience of the synchronization. A Naval orange juice sac was used as the sample. Three different volume sizes are tested: 250×160×512 voxels (40,000 A-scans/volume); 250×80×512 voxels (20,000 A-scans/volume); 125×80×512 voxels (10,000 A-scans/volume); corresponding to a volume rate of 2.5, 5 and 10 volume/second, respectively. FIG. 8 shows the en face slices of approximately 1 mm×1 mm region in two different depths extracted from the same volumetric data and the depth difference of about 25 μm. All the A-scans of one volume were acquired and processed as one batch and remapped for en face slice extraction. More than one en face images at different depth can be quickly reconstructed and displayed simultaneously since the complete 3D data is available. As one can see, with decreasing volume size and increasing volume rate, the image quality degenerates, but the major details such as cell wall are still clear enough to be visible compared with the largest volume size slices as in FIGS. 8A and 8B.

Here it is necessary to compare an en face FD-OCT imaging with another en face OCT imaging technology—time-domain transverse-scanning OCT/OCM (TD-TS-OCT/OCM) which acquires only one resolution element per A-scan. A typical TD-TS-OCT/OCM system can achieve a large en face image size (250,000 pixels) at 4 frame/s (A. D. Aguirre, P. Hsiung, T. H. Ko, I. Hartl, and J. G. Fujimoto, “High-resolution optical coherence microscopy for high-speed, in vivo cellular imaging,” Opt. Lett. 28, 2064-2066 (2003)), giving 1,000,000 transverse points per second. In contrast, en face FD-OCT has less transverse scan rate (typically <500,000 A-scan/s) because a whole spectrum has to be acquired for each A-scan. However, en face FD-OCT provides a complete 3D data set so multiple en face images at different depth of the volume can be extracted simultaneously, which is not available by TD-TS-OCT/OCM.

### Volumetric Visualization by Ray-Casting

Next we implemented the real-time volume rendering of continuous acquired data volume and realized the 10 volume per second 4D FD-OCT “live” image. The acquisition line rate is set to be 125,000 line/s at 1024-OCT mode. The acquisition volume size is set to be 12,500 A-scans, providing 125(X)×100(Y)×512(Z) voxels after the signal processing stage, which takes less than 10 ms and leaves more than 90 ms for each volume interval at the volume rate of 10 volume/s. As noticed from FIG. 6A, the 1024-OCT has a 10-dB roll-off depth of about 0.8 mm, and the background noise also increases with the depth. Therefore the optimum volume for the rendering in the visualization stage is truncated in half from the acquisition volume to be 125(X)×100(Y)×256(Z) voxels excluding the DC component and the low SNR portion in each A-scan. Nevertheless, the whole volume rendering is available if a larger image range is required. The image plane is set to 512×512 pixels, which means a total number of 512²=262144 eye rays are used to accumulate through the whole rendering volume for the ray-casting process according to Eq. (4) and Eq. (5). The actual rendering time is recorded during the imaging processing to be ˜3 ms for half volume and ˜6 ms for full volume, which is much shorter than the volume interval residual (>90 ms). Also for the purpose of demonstrating the higher acquisition speed case, the data transfer-in, the complete FD-OCT processing and the volume rendering of the same frame were repeated 3 times within each volume period, while still maintaining 10 volume/s real-time rendering. Therefore a minimum effective processing and visualization speeds of 375,000 A-scan/s for 1024-OCT can be expected.

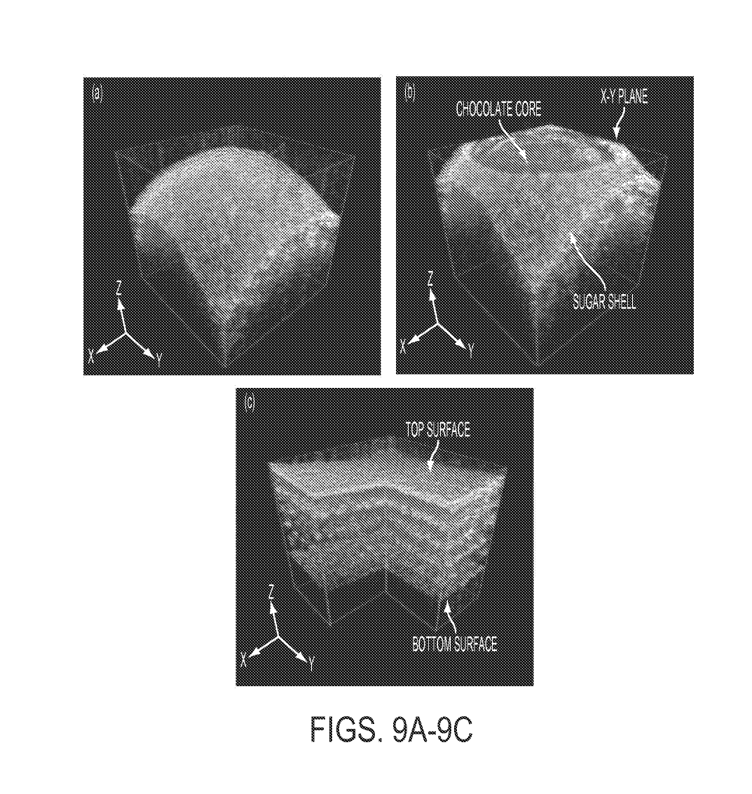

First we tested the real-time visualization ability by imaging non-biological samples. Here the half volume rendering is applied and the real volume size is approximately 4 mm×4 mm×0.66 mm. The dynamic scenarios are captured by free screen-recording software (BB FlashBack Express). FIG. 9A presents the top surface of a piece of sugar-shell coated chocolate, which is moving up and down in axial direction with a manual translation stage. Here the perspective projection is used for the eye's viewpoint (J. Kruger and R. Westermann, “Acceleration techniques for GPU-based volume rendering,” in Proceedings of the 14th IEEE Visualization Conference (VIS'03) (IEEE Computer Society, Washington, D.C., 2003), pp. 287-292), and the rendering volume frame is indicated by the white lines. As played in Media 1, FIG. 9B shows the situation when the target surface is truncated by the rendering volume's boundary, the X-Y plane, where the sugar shell is virtually “peeled” and the inner structures of the chocolate core is clearly recognizable. FIG. 9C illustrates a five-layer plastic phantom mimicking the retina, where the layers are easily distinguishable. The volume rendering frame in FIG. 9C is configured as “L” shape so the tapes are virtually “cut” to reveal the inside layer structures.

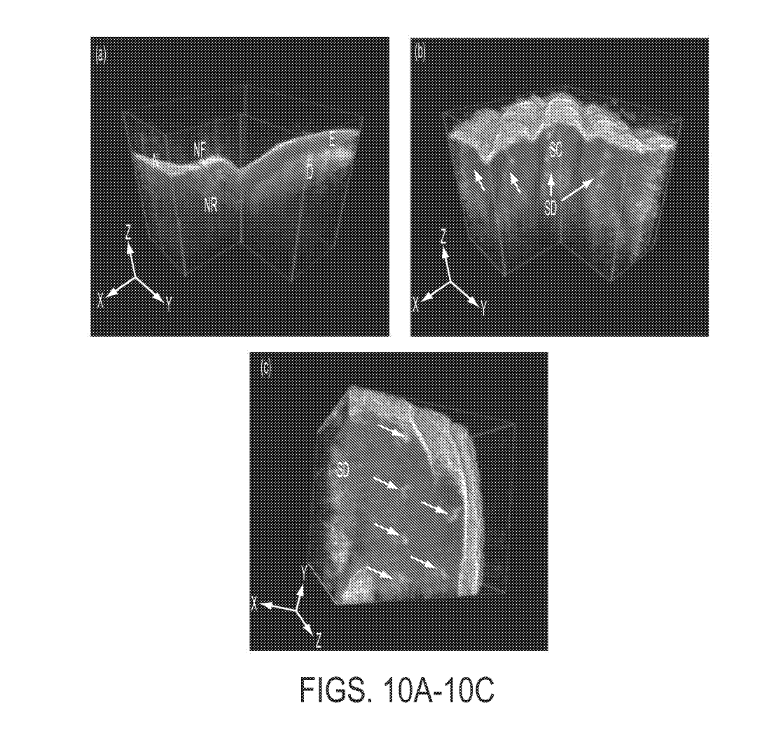

We next implemented the in vivo real-time 3D imaging of a human fingertip. FIG. 10A shows the skin and fingernail connection, the full volume rendering is applied here giving a real size of 4 mm×4 mm×1.32 mm considering the large topology range of the nail connection region. The major dermatologic structures such as epidermis (E), dermis (D), nail fold (NF), nail root (NF) and nail body (N) are clearly distinguishable from FIG. 10A. Media 2 captured the dynamic scenario of the finger's vertical vibration due to artery pulsing when the finger is firmly pressing against the sample stage. The fingerprint is imaged and shown in FIG. 10B, where the epithelium structures such as sweat duct (SD), stratum corneum (SC) can be clearly identified. FIG. 10C offers a top-view of the fingerprint region, where the surface is virtually peeled by the image frame and the inner sweat duct are clearly visible. The volume size for FIG. 10B and FIG. 10C is 2 mm×2 mm×0.66 mm.

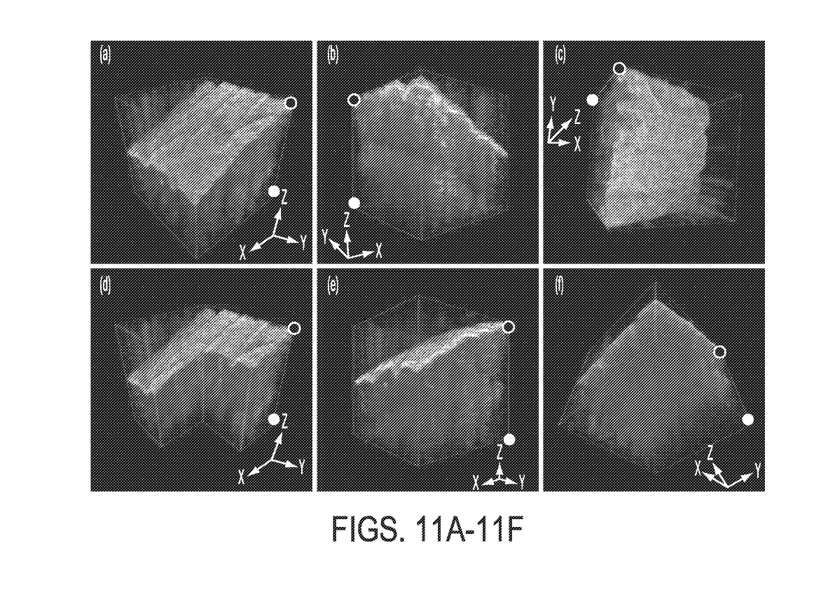

Finally, to make full use of the ultrahigh processing speed and the whole 3D data, we implemented multiple 2D frames real-time rendering from the same 3D data set with different modelview matrix, including side-view (FIGS. 11A, 11B, 11D, 11E), top-view (FIG. 11C) and bottom-view (FIG. 11F), where FIG. 11A and FIG. 11D are actually using the same modelview matrix but the later displayed with the “L” volume rendering frame to give more information of inside. All frames are rendered within the same volume period and displayed simultaneously, thus gives more comprehensive information of the target. The two vertexes with the big red and green dot indicate the same edge for each rendering volume frame.

The processing bandwidth in the example above is much higher than most of the current FD-OCT system's acquisition speed, which indicates a huge potential for improving the image quality and volume speed of real-time 3D FD-OCT by increasing the acquisition bandwidth. The GPU processing speed can be increased even higher by implementing a multiple-GPU architecture using more than one GPU in parallel. Therefore the bottleneck for 3D FD-OCT imaging would now lie in the acquisition speed.

For all the experiments described above, the only additional device required to implement the real-time high speed OCT data processing and display for most cases is a high-end graphics card which cost far less compared to most optical setups and acquisition devices. The graphics card is plug-and-play computer hardware without the need for any optical modifications. And it is much simpler than adding a prism to build a linear-k spectrometer or developing a linear-k swept laser. Both are complicated to build and will change the overall physical behavior of the OCT system.

### Conclusion

In conclusion, we realized GPU based real-time 4D signal processing and visualization on a regular FD-OCT system with nonlinear k-space for the first time to the best of our knowledge. An ultra-high speed linear spline interpolation (LSI) method for interpolation for λ-to-k spectral re-sampling is implemented in GPU architecture. The complete FD-OCT signal processing including interpolation for λ-to-k spectral re-sampling, fast Fourier transform (FFT) and post-FFT processing have all been implemented on a GPU. 3D Data sets are continuously acquired in real time, immediately processed and visualized by either en face slice extraction or ray-casting based volume rendering from 3D texture mapped in graphics memory. For standard FD-OCT systems, a GPU is the only additional hardware needed to realize this improvement and no optical modification is needed. This technique is highly cost-effective and can be easily integrated into most ultrahigh speed FD-OCT systems to overcome the 3D data processing and visualization bottlenecks.

### Example 2

As mentioned above, for most conventional FD-OCT systems, the raw data is acquired in real-time and saved for post-processing. For microsurgeries, such imaging protocol provides valuable “pre-operative/post-operative” images, but is incapable of providing real-time, “inter-operative” imaging for surgical guidance and visualization. In addition, standard FD-OCT systems suffer from spatially reversed complex-conjugate ghost images that could severely misguide the users. As a solution, the complex full-range FD-OCT (C-FD-OCT) has been utilized, which removes the complex-conjugate image by applying a phase modulation on interferogram frames. See, for example:
Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt. 45, 1861-1865 (2006).
B. Baumann, M. Pircher, E. Götzinger and C. K. Hitzenberger, “Full range complex spectral domain optical coherence tomography without additional phase shifters,” Opt. Express 15, 13375-13387 (2007), http://www.opticsinfobase.org/abstract.cfm?URI=oe-15-20-13375
L. An and R. K. Wang, “Use of a scanner to modulate spatial interferograms for in vivo full-range Fourier-domain optical coherence tomography,” Opt. Lett. 32, 3423-3425 (2007).
S. Vergnole, G. Lamouche, and M. L. Dufour, “Artifact removal in Fourier-domain optical coherence tomography with a piezoelectric fiber stretcher,” Opt. Lett. 33, 732-734 (2008).
H. M. Subhash, L. An, and R. K. Wang, “Ultra-high speed full range complex spectral domain optical coherence tomography for volumetric imaging at 140,000 A scans per second,” Proc. SPIE 7554, 75540K (2010).

A 140 k line/s 2048-pixel C-FD-OCT has been implemented for volumetric anterior chamber imaging (Subhash et al). However, the complex-conjugate processing is even more time-consuming and presents an extra burden when providing real-time images during surgical procedures.

Several methods have been implemented to improve data processing and visualization of FD-OCT images: Field-programmable gate array (FPGA) has been applied to both spectrometer and swept source-based systems (T. E. Ustun, N. V. Iftimia, R. D. Ferguson, and D. X. Hammer, “Real-time processing for Fourier domain optical coherence tomography using a field programmable gate array,” Rev. Sci. Instrum. 79, 114301 (2008); A. E. Desjardins, B. J. Vakoc, M. J. Suter, S. H. Yun, G. J. Tearney, B. E. Bouma, “Real-time FPGA processing for high-speed optical frequency domain imaging,” IEEE Trans. Med. Imaging 28, 1468-1472 (2009)); multi-core CPU parallel processing has been implemented and achieved 80,000 line/s processing rate on nonlinear-k polarization-sensitive OCT system and 207,000 line/s on linear-k systems, both with 1024-point/A-scan (G. Liu, J. Zhang, L. Yu, T. Xie, and Z. Chen, “Real-time polarization-sensitive optical coherence tomography data processing with parallel computing,” Appl. Opt. 48, 6365-6370 (2009); J. Probst, D. Hillmann, E. Lankenau, C. Winter, S. Oelckers, P. Koch, G. Hüttmann, “Optical coherence tomography with online visualization of more than seven rendered volumes per second,” J. Biomed. Opt. 15, 026014 (2010)). Moreover, recent progress in general-purpose computing on graphics processing units (GPGPU) makes it possible to implement heavy-duty OCT data processing and visualization on a variety of low-cost, many-core graphics cards.

For standard half-range FD-OCT, GPU-based data processing has been implemented on both linear-k and non-linear-k systems (Y. Watanabe and T. Itagaki, “Real-time display on Fourier domain optical coherence tomography system using a graphics processing unit,” J. Biomed. Opt. 14, 060506 (2009); K. Zhang and J. U. Kang, “Real-time 4D signal processing and visualization using graphics processing unit on a regular nonlinear-k Fourier-domain OCT system,” Opt. Express 18, 11772-11784 (2010), http://www.opticsinfobase.org/abstract.cfm?uri=oe-18-11-11772; S. V. Jeught, A. Bradu, and A. G. Podoleanu, “Real-time resampling in Fourier domain optical coherence tomography using a graphics processing unit,” J. Biomed. Opt. 15, 030511 (2010)). Real-time 4D OCT imaging has also been achieved up to 10 volume/s through GPU-based volume rendering (Probst et al.; Zhang et al., id.). We have found that, based on a 1024-pixel standard FD-OCT system using NVIDIA's GTX 480 GPU, the maximum processing line rate in this example is >3,000,000 line/s (effectively >1,000,000 line/s under data transfer limit), which will be shown in detail below.

For complex full-range FD-OCT, the processing workload is more than 3 times the standard OCT, since each A-scan requires three fast Fourier transforms (FFT) in different dimensions of the frame, a band-pass filtering, and performing a necessary matrix transpose (Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt. 45, 1861-1865 (2006)). In a separate work, we realized a real-time processing of 1024-pixel C-FD-OCT at >500,000 line/s (effectively >300,000 line/s under data transfer limit), and a real-time camera-limited display speed of 244,000 line/s (J. U. Kang and K. Zhang, “Real-time complex optical coherence tomography using graphics processing unit for surgical intervention,” to appear on IEEE Photonics Society Annual 2010, Denver, Colo., USA, November, 2010). Very recently, a 27,900 line/s 2048-pixel C-FD-OCT system was reported by Watanabe et al during the preparation of this manuscript (Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010)).

In most FD-OCT systems, the signal is sampled nonlinearly in k-space, which will seriously degrade the image quality if the FFT is directly applied to such signal. So far there have been both hardware and software solutions to the nonlinear-k issue. Hardware solutions such as linear-k spectrometer (Z. Hu and A. M. Rollins, “Fourier domain optical coherence tomography with a linear-in-wavenumber spectrometer,” Opt. Lett. 32, 3525-3527 (2007)), linear-k swept laser (C. M. Eigenwillig, B. R. Biedermann, G. Palte, and R. Huber, “K-space linear Fourier domain mode locked laser and applications for optical coherence tomography,” Opt. Express 16, 8916-8937 (2008), http://www.opticsinfobase.org/oe/abstract.cfm?URI=oe-16-12-8916) and k-triggering (D. C. Adler, Y. Chen, R. Huber, J. Schmitt, J. Connolly, and J. G. Fujimoto, “Three-dimensional endomicroscopy using optical coherence tomography,” Nat. Photonics 1,709-716 (2007)) have been successfully implemented, but these methods generally increase the system complexity and cost. Software solutions include various interpolation methods such as simple linear interpolation, oversampled linear interpolation, zero-filling linear interpolation, and cubic spline interpolation. Different GPU-based interpolation methods have also been implemented and compared (Y. Watanabe and T. Itagaki, “Real-time display on Fourier domain optical coherence tomography system using a graphics processing unit,” J. Biomed. Opt. 14, 060506 (2009); K. Zhang and J. U. Kang, “Real-time 4D signal processing and visualization using graphics processing unit on a regular nonlinear-k Fourier-domain OCT system,” Opt. Express 18, 11772-11784 (2010), http://www.opticsinfobase.org/abstract.cfm?uri=oe-18-11-11772; S. V. Jeught, A. Bradu, and A. G. Podoleanu, “Real-time resampling in Fourier domain optical coherence tomography using a graphics processing unit,” J. Biomed. Opt. 15, 030511 (2010)). Alternatively, the non-uniform discrete Fourier transform (NUDFT) has been proposed recently for both swept source OCT (S. S. Sherif, C. Flueraru, Y. Mao, and S. Change, “Swept Source Optical Coherence Tomography with Nonuniform Frequency Domain Sampling,” in Biomedical Optics, OSA Technical Digest (CD) (Optical Society of America, 2008), paper BMD86) and spectrometer-based OCT (K. Wang, Z. Ding, T. Wu, C. Wang, J. Meng, M. Chen, and L. Xu, “Development of a non-uniform discrete Fourier transform based high speed spectral domain optical coherence tomography system,” Opt. Express 17, 12121-12131 (2009),

http://www.opticsinfobase.org/oe/abstract.cfm?URI=oe-17-14-12121) through direct Vandermonde matrix multiplication with the spectrum vector. Compared with the interpolation-FFT (InFFT) method, NUDFT is simpler to implement and immune to the interpolation-caused errors such as increased background noise and side-lobes, especially at larger image depth (Sébastien Vergnole, Daniel Lévesque, and Guy Lamouche, “Experimental validation of an optimized signal processing method to handle non-linearity in swept-source optical coherence tomography,” Opt. Express 18, 10446-10461 (2010), http://wwvv.opticsinfobase.org/abstract.cfm?uri=oe-18-10-10446). Moreover, NUDFT has improved sensitivity roll-off than the InFFT (Wang et al., id.). However, NUDFT by direct matrix multiplication is extremely time-consuming, with a complexity of O(N²), where N is the raw data size of an A-scan. As an approximation to NUDFT, the gridding-based non-uniform fast Fourier transform (NUFFT) has been tried to process simulated (D. Hillmann, G. Huttmann, and P. Koch, “Using nonequispaced fast Fourier transformation to process optical coherence tomography signals,” Proc. SPIE 7372, 73720R (2009)) and experimentally acquired data (Vergnole et al) with reduced calculation complexity of ˜O(NlogN). To the best of our knowledge, NUDFT/NUFFT have yet to be utilized in ultra-high speed, real-time FD-OCT systems due to computational complexity and associated latency in data processing.

In this example according to an embodiment of the current invention, we implemented the fast Gaussian gridding (FGG)-based NUFFT on the GPU architecture for ultrafast signal processing in a general FD-OCT system. The Vandermonde matrix-based NUDFT as well as the linear/cubic InFFT methods are also implemented on GPU as comparisons of image quality and processing speed. GPU-NUFFT provides a very close approximation to GPU-NUDFT in terms of image quality while offering >10 times higher processing speed. Compared with the GPU-InFFT methods, we have also observed improved sensitivity roll-off, a higher local signal-to-noise ratio, and absence of side-lobe artifacts in GPU-NUFFT. Using a high speed CMOS line-scan camera, we demonstrated the real-time processing and display of GPU-NUFFT-based C-FD-OCT at a camera-limited speed of 122 k line/s (1024 pixel/A-scan).

### System Configuration

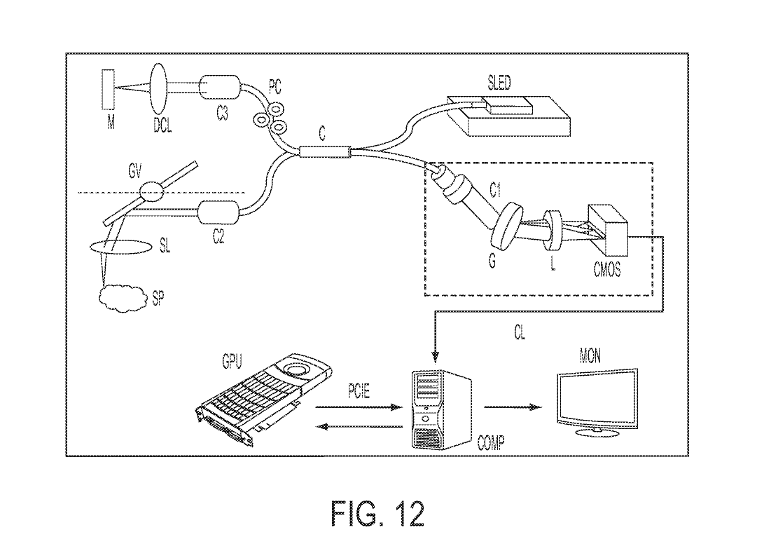

The FD-OCT system used in this work is spectrometer-based, as shown in FIG. 12. A 12-bit dual-line CMOS line-scan camera (Sprint spL2048-140k, Basler AG, Germany) functions as the detector of the OCT spectrometer. A superluminescence diode (SLED) (4=825 nm, 61=70 nm, Superlum, Ireland) was used as the light source, which provided a theoretical axial resolution of approximately 5.5 μm in air, 4.1 μm in water. Since the SLED's spectrum only covers less than half of the CMOS camera's sensor array, the camera is set to work at 1024-pixel mode by selecting the area-of-interest (AOI). The camera works at the “dual-line averaging mode” to get 3 dB higher SNR of the raw spectrum (B. Potsaid, I. Gorczynska, V. J. Srinivasan, Y. Chen, J. Jiang, A. Cable, and J. G. Fujimoto, “Ultrahigh speed Spectral/Fourier domain OCT ophthalmic imaging at 70,000 to 312,500 axial scans per second,” Opt. Express 16, 15149-15169 (2008), http://www.opticsinfobase.org/oe/abstract.cfm?uri=oe-16-19-15149), and the minimum line period is camera-limited to 7.8 μs, which corresponds to a maximum line rate of 128 k A-scan/s. The beam scanning was implemented by a pair of high speed galvanometer mirrors driven by a dual channel function generator and synchronized with a high speed frame grabber (PCIE-1429, National Instruments, USA). For C-FD-OCT mode, a phase modulation is applied to each B-scan's 2D interferogram frame by slightly displacing the probe beam off the first galvanometer's pivoting point (here only the first galvanometer is illustrated in the figure) (B. Baumann, M. Pircher, E. Götzinger and C. K. Hitzenberger, “Full range complex spectral domain optical coherence tomography without additional phase shifters,” Opt. Express 15, 13375-13387 (2007), http://www.opticsinfobase.org/abstract.cfm?URI=oe-15-20-13375; L. An and R. K. Wang, “Use of a scanner to modulate spatial interferograms for in vivo full-range Fourier-domain optical coherence tomography,” Opt. Lett. 32, 3423-3425 (2007)). The scanning angle is 8° and the beam offset is 1.4 mm, therefore a carrier frequency of 30 kHz is obtained according to reference (Baumann et al.). The transversal resolution was approximately 20 μm, assuming Gaussian beam profile. A quad-core Dell T7500 workstation was used to host the frame grabber (PCIE x4 interface) and GPU (PCIE x16), and a GPU (NVIDIA GeForce GTX 480) with 480 stream processors (each processor working at 1.45 GHz) and 1.5 GBytes graphics memory was used to perform the FD-OCT signal processing. The GPU is programmed through NVIDIA's Compute Unified Device Architecture (CUDA) technology (NVIDIA, “NVIDIA CUDA Compute Unified Device Architecture Programming Guide Version 3.1,” (2010)). The FFT operation is implemented by the CUFFT library (NVIDIA, “NVIDIA CUDA CUFFT Library Version 3.1,” (2010)). The software is developed under Microsoft Visual C++ environment with the NI-IMAQ Win32 API (National Instrument).

### Implementation of GPU-NUDFT and GPU-NUFFT in FD-OCT Systems

In this section, the implementation of both GPU-NUDFT and GPU-NUFFT in a standard FD-OCT system is described. For the implementation, the wavenumber-pixel relation of the system k[i]=2π/λ[i] is pre-calibrated accurately, where refers to the pixel index.

### GPU-NUDFT in FD-OCT

After pre-calibrating the k[i] relation, the depth information A[zₘ] can be implemented through discrete Fourier transform over non-uniformly distributed data I[kᵢ], as in (S. S. Sherif, C. Flueraru, Y. Mao, and S. Change, “Swept Source Optical Coherence Tomography with Nonuniform Frequency Domain Sampling,” in Biomedical Optics, OSA Technical Digest (CD) (Optical Society of America, 2008), paper BMD86.

K. Wang, Z. Ding, T. Wu, C. Wang, J. Meng, M. Chen, and L. Xu, “Development of a non-uniform discrete Fourier transform based high speed spectral domain optical coherence tomography system,” Opt. Express 17, 12121-12131 (2009), http://wwvv.opticsinfobase.org/oe/abstract.cfm?URI=oe-17-14-12121; Sébastien Vergnole, Daniel Lévesque, and Guy Lamouche, “Experimental validation of an optimized signal processing method to handle non-linearity in swept-source optical coherence tomography,” Opt. Express 18, 10446-10461 (2010), http://www.opticsinfobase.org/abstract.cfm?uri=oe-18-10-10446),

$$A [ {z}_{m} ] = {\sum }_{i = 0}^{N - 1} I [ {k}_{i} ] exp [ - j \frac{2 π}{Δ k} ( {k}_{i} - {k}_{0} ) * m ] , \\ m = 0 , 1 , 2 , … , N - 1. \qquad ( 2.1 )$$

where N is the total pixel number of a spectrum, zₘ refers to the depth coordinate with the pixel index m. Δk=k_{N-1}−k₀ is the wavenumber range.

For standard FD-OCT, where I[kᵢ] are real-values, Eq. (2.1) can be reduce to half-range as,

$$A [ {z}_{m} ] = {\sum }_{i = 0}^{N - 1} I [ {k}_{i} ] exp [ - j \frac{2 π}{Δ k} ( {k}_{i} - {k}_{0} ) * m ] , \\ m = 0 , 1 , 2 , … , N / 2 - 1. \qquad ( 2.2 )$$

For C-FD-OCT, where I[kⱼ] are complex-values after Hilbert transform (Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt. 45, 1861-1865 (2006)), Eq. (1) can be modified to full-range as,

$$A [ {z}_{m} ] = {\sum }_{i = 0}^{N - 1} I [ {k}_{i} ] exp [ - j \frac{2 π}{Δ k} ( {k}_{i} - {k}_{0} ) * ( m - \frac{N}{2} ) ] , \\ m = 0 , 1 , 2 , … , N - 1. \qquad ( 2.3 )$$

here the index m is shifted by N/2 to set the DC component to the center of A[zₘ]. Considering a frame with M A-scans, Equations (2.2) and (2.3) can be written in matrix form for processing the whole frame as,

$$\begin{matrix}{A}_{half} = [ \begin{matrix}{A}_{0} [ {z}_{0} ] & {A}_{1} [ {z}_{0} ] & ⋯ & {A}_{M - 2} [ {z}_{0} ] & {A}_{M - 1} [ {z}_{0} ] \\ {A}_{0} [ {z}_{1} ] & {A}_{1} [ {z}_{1} ] & ⋯ & {A}_{M - 2} [ {z}_{1} ] & {A}_{M - 1} [ {z}_{1} ] \\ ⋮ & ⋮ & ⋱ & ⋮ & ⋮ \\ {A}_{0} [ {z}_{N / 2 - 2} ] & {A}_{1} [ {z}_{N / 2 - 2} ] & ⋯ & {A}_{M - 2} [ {z}_{N / 2 - 2} ] & {A}_{M - 1} [ {z}_{N / 2 - 2} ] \\ {A}_{0} [ {z}_{N / 2 - 1} ] & {A}_{1} [ {z}_{N / 2 - 1} ] & ⋯ & {A}_{M - 2} [ {z}_{N / 2 - 1} ] & {A}_{M - 1} [ {z}_{N / 2 - 1} ]\end{matrix} ] , & ( 2.5 ) \\ {I}_{real} = [ \begin{matrix}{I}_{0} [ {z}_{0} ] & {I}_{1} [ {z}_{0} ] & ⋯ & {I}_{M - 2} [ {z}_{0} ] & {I}_{M - 1} [ {z}_{0} ] \\ {I}_{0} [ {z}_{1} ] & {I}_{1} [ {z}_{1} ] & ⋯ & {I}_{M - 2} [ {z}_{1} ] & {I}_{M - 1} [ {z}_{1} ] \\ ⋮ & ⋮ & ⋱ & ⋮ & ⋮ \\ {I}_{0} [ {z}_{N - 2} ] & {I}_{1} [ {z}_{N - 2} ] & ⋯ & {I}_{M - 2} [ {z}_{N - 2} ] & {I}_{M - 1} [ {z}_{N - 2} ] \\ {I}_{0} [ {z}_{N - 1} ] & {I}_{1} [ {z}_{N - 1} ] & ⋯ & {I}_{M - 2} [ {z}_{N - 1} ] & {I}_{M - 1} [ {z}_{N - 1} ]\end{matrix} ] , & ( 2.6 ) \\ {D}_{half} = [ \begin{matrix}1 & 1 & ⋯ & 1 & 1 \\ {p}_{0}^{- 1} & {p}_{1}^{- 1} & ⋯ & {p}_{N - 2}^{- 1} & {p}_{N - 1}^{- 1} \\ ⋮ & ⋮ & ⋱ & ⋮ & ⋮ \\ {p}_{0}^{- ( N / 2 - 2 )} & {p}_{1}^{- ( N / 2 - 2 )} & ⋯ & {p}_{N - 2}^{- ( N / 2 - 2 )} & {p}_{N - 1}^{- ( N / 2 - 2 )} \\ {p}_{0}^{- ( N / 2 - 1 )} & {p}_{1}^{- ( N / 2 - 1 )} & ⋯ & {p}_{N - 2}^{- ( N / 2 - 1 )} & {p}_{N - 1}^{- ( N / 2 - 1 )}\end{matrix} ] \\ And & ( 2.7 ) \\ \begin{matrix}{A}_{full} = {D}_{full} {I}_{complex} , & ( Complex full \text{-} range FD \text{-} OCT )\end{matrix} & ( 2.8 ) \\ {A}_{full} = [ \begin{matrix}{A}_{0} [ {z}_{0} ] & {A}_{1} [ {z}_{0} ] & ⋯ & {A}_{M - 2} [ {z}_{0} ] & {A}_{M - 1} [ {z}_{0} ] \\ {A}_{0} [ {z}_{1} ] & {A}_{1} [ {z}_{1} ] & ⋯ & {A}_{M - 2} [ {z}_{1} ] & {A}_{M - 1} [ {z}_{1} ] \\ ⋮ & ⋮ & ⋱ & ⋮ & ⋮ \\ {A}_{0} [ {z}_{N - 2} ] & {A}_{1} [ {z}_{N - 2} ] & ⋯ & {A}_{M - 2} [ {z}_{N - 2} ] & {A}_{M - 1} [ {z}_{N - 2} ] \\ {A}_{0} [ {z}_{N - 1} ] & {A}_{1} [ {z}_{N - 1} ] & ⋯ & {A}_{M - 2} [ {z}_{N - 1} ] & {A}_{M - 1} [ {z}_{N - 1} ]\end{matrix} ] , & ( 2.9 ) \\ {I}_{complex} = [ \begin{matrix}{I}_{0} [ {z}_{0} ] & {I}_{1} [ {z}_{0} ] & ⋯ & {I}_{M - 2} [ {z}_{0} ] & {I}_{M - 1} [ {z}_{0} ] \\ {I}_{0} [ {z}_{1} ] & {I}_{1} [ {z}_{1} ] & ⋯ & {I}_{M - 2} [ {z}_{1} ] & {I}_{M - 1} [ {z}_{1} ] \\ ⋮ & ⋮ & ⋱ & ⋮ & ⋮ \\ {I}_{0} [ {z}_{N - 2} ] & {I}_{1} [ {z}_{N - 2} ] & ⋯ & {I}_{M - 2} [ {z}_{N - 2} ] & {I}_{M - 1} [ {z}_{N - 2} ] \\ {I}_{0} [ {z}_{N - 1} ] & {I}_{1} [ {z}_{N - 1} ] & ⋯ & {I}_{M - 2} [ {z}_{N - 1} ] & {I}_{M - 1} [ {z}_{N - 1} ]\end{matrix} ] , & ( 2.10 ) \\ {D}_{full} = [ \begin{matrix}{p}_{0}^{+ ( N / 2 )} & {p}_{1}^{+ ( N / 2 )} & ⋯ & {p}_{N - 2}^{+ ( N / 2 )} & {p}_{N - 1}^{+ ( N / 2 )} \\ {p}_{0}^{+ ( N / 2 - 1 )} & {p}_{1}^{+ ( N / 2 - 1 )} & ⋯ & {p}_{N - 2}^{+ ( N / 2 - 1 )} & {p}_{N - 2}^{+ ( N / 2 - 1 )} \\ ⋮ & ⋮ & ⋱ & ⋮ & ⋮ \\ {p}_{0}^{- ( N / 2 - 2 )} & {p}_{1}^{- ( N / 2 - 2 )} & ⋯ & {p}_{N - 2}^{- ( N / 2 - 2 )} & {p}_{N - 1}^{- ( N / 2 - 2 )} \\ {p}_{0}^{- ( N / 2 - 1 )} & {p}_{1}^{- ( N / 2 - 1 )} & ⋯ & {p}_{N - 2}^{- ( N / 2 - 1 )} & {p}_{N - 1}^{- ( N / 2 - 1 )}\end{matrix} ] , & ( 2.11 )\end{matrix}$$

where the subscript of A[zₘ] and I[kᵢ] denotes the index of A-scan within one frame, the complex factor pᵢ=exp[j2π/Δk*(kᵢ−k₀)], D_{half} and D_{full} are the Vandermonde matrix, which can be pre-calculated from k[i].

To realize C-FD-OCT mode, a phase modulation φ(x)=βx is applied to each B-scan's 2D interferogram frame I(k,x) by slightly displacing the probe beam off the galvanometer's pivoting point, as shown in FIG. 12. Here x indicates A-scan index in each B-scan and by applying Fourier transform along x direction, the following equation can be obtained (Yasuno et al.):

$${F}_{x \to u} [ I ( k , x ) ] = {\vert {E}_{r} ( k ) \vert}^{2} δ ( u ) + {Γ}_{u} \{ {F}_{x \to u} [ {E}_{s} ( k , x ) ] \} + {F}_{x \to u} [ {E}_{r}^{*} ( k , x ) {E}_{r} ( k ) ] ⊗ δ ( u + β ) + {F}_{x \to u} [ {E}_{s} ( k , x ) {E}_{r}^{*} ( k ) ] ⊗ δ ( u - β ) , \qquad ( 2.12 )$$

where Eₛ (k,x) and Eᵣ (k) are the electrical fields from the sample and reference arms, respectively. Γᵤ{ } is the correlation operator. The first three terms on the right hand of Eq. (2.12) present the DC noise, autocorrelation noise, and complex-conjugate noise, respectively. The last term can be filtered out by a proper band-pass filter in the u domain and then convert back to x domain by applying an inverse Fourier transform along x direction. Here, to implement the standard Hilbert transform, we use the Heaviside step function as the band-pass filter and the more delicate filters such as super Gaussian filter can also be designed to optimize the performance (Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010)). Finally, the OCT image is obtained by NUDFT in k domain and logarithmically scaled for display.

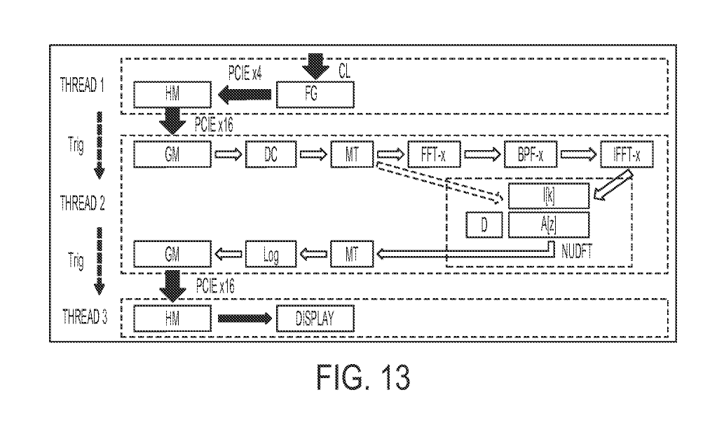

The GPU-CPU hybrid processing flowchart for standard/complex FD-OCT using GPU-NUDFT is shown in FIG. 13, where three major threads are used for the data acquisition (Thread 1), the GPU processing (Thread 2), and the image display (Thread 3), respectively. The three threads are triggered unidirectionally and work in the synchronized pipeline mode, as indicated by the blue dashed arrows in FIG. 13. Thread 2 is a GPU-CPU hybrid thread which consists of hundreds of thousands of GPU threads. The solid arrows describe the main data stream and the hollow arrows indicate the internal data flow of the GPU. The DC removal is implemented by subtracting a pre-stored frame of reference signal. The Vandermonde matrix D_{half}/D_{full} is pre-calculated and stored in graphics memory, as the blue block in FIG. 13. The NUDFT is implemented by an optimized matrix multiplication algorithm on CUDA using shared memory technology for the maximum usage of the GPU's floating point operation ability (NVIDIA, “NVIDIA CUDA C Best Practices Guide 3.1,” (2010)). The graphics memory mentioned at the current stage of our system refers to global memory, which has relatively lower bandwidth and is another major limitation of GPU processing in addition to the PCIE x16 bandwidth limit. The processing speed can be further increased by mapping to texture memory, which has higher bandwidth than global memory.

### 3.2 GPU-NUFFT in FD-OCT

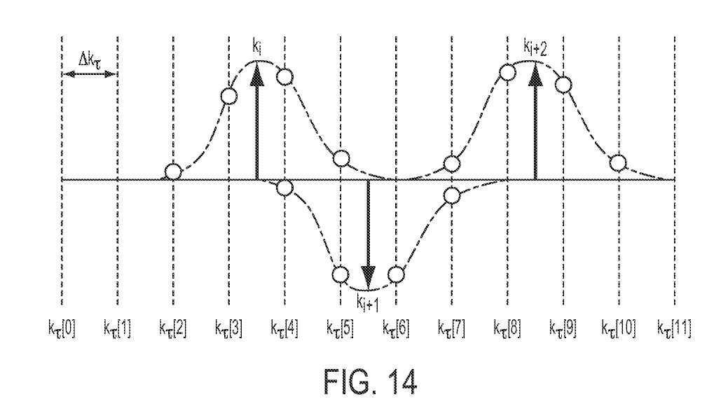

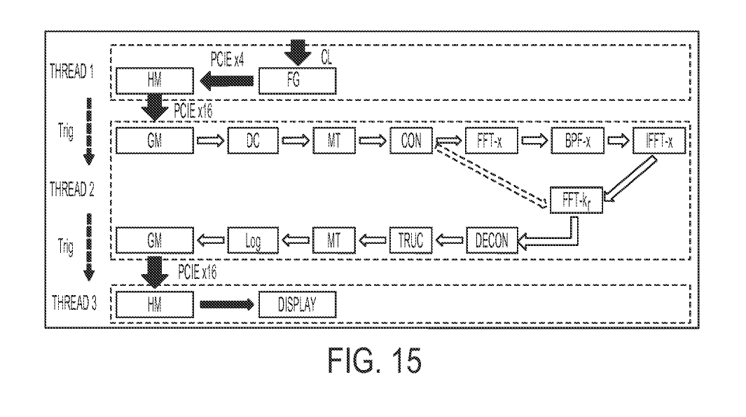

The direct GPU-NUDFT presented above has a computation complexity of O(N²), which greatly limits the computation speed and scalability for real-time display even on a GPU, as is shown experimentally below. Alternative to direct GPU-NUDFT, here we implemented fast Gaussian gridding-based GPU-NUFFT to approximate GPU-NUDFT: the raw signal I[kᵢ] is first oversampled by convolution with a Gaussian interpolation kernel on a uniform grid, as [40],

$$\begin{matrix}{I}_{τ} [ u ] = {\sum }_{i} [ i ] {g}_{τ} [ {k}_{τ} [ u ] - k [ i ] ] , u = 0 , 1 , 2 , … , Mr - 1. & ( 2.13 ) \\ {g}_{τ} [ k ] = exp [ \frac{- {k}^{2}}{4 τ} ] , & ( 2.14 ) \\ τ = \frac{1}{{N}^{2}} \frac{π}{R ( R - 0.5 )} {M}_{sp} , & ( 2.15 ) \\ {G}_{τ} [ n ] = exp [ {n}^{2} τ ] , & ( 2.16 )\end{matrix}$$

where k_{τ}[u] is uniform grid covering the same range as k[i], g_{τ}[k] is the Gaussian interpolation kernel, Mᵣ=R*N is the uniform gridding size, and R is the oversampling ratio. On each k_{τ}[u] grid, the source data I[i] is selected such that k_{τ}[u] is within the nearest 2*Mₛₚ grids to k[i], where Mₛₚ is the kernel spread factor. The calculation of Eq. (2.13) is illustrated in FIG. 14, where we set R=2, Mₛₚ=2 and values of the blue dots on the same k_{τ}[u] grid are summed together to obtain I_{τ}[u]. The selection of proper R and Mₛₚ will be further discussed below. Subsequently I_{τ}[u] is processed by the regular uniform FFT and finally undergo a deconvolution of g_{τ}[k] by multiplying the factor G_{τ}[n], as in Eq. (2.16), where n denotes the axial index. If R>1, there will be redundant data due to oversampling and the final data needs to be truncated to the size of N. The processing flowchart of GPU-NUFFT-based FD-OCT is shown in FIG. 15.

Here it is worth noting that the Kaiser-Bessel function is found to be the optimal convolution kernel for the gridding-based NUFFT shown in recent works (Sébastien Vergnole, Daniel Lévesque, and Guy Lamouche, “Experimental validation of an optimized signal processing method to handle non-linearity in swept-source optical coherence tomography,” Opt. Express 18, 10446-10461 (2010), http://www.opticsinfobase.org/abstract.cfm?uri=oe-18-10-10446; D. Hillmann, G. Huttmann, and P. Koch, “Using nonequispaced fast Fourier transformation to process optical coherence tomography signals,” Proc. SPIE 7372, 73720R (2009)). The implementation of Kaiser-Bessel convolution on GPU is similar to the Gaussian kernel.

### GPU Processing Test and Comparison of Different FD-OCT Methods

GPU Processing Line Rate for Different FD-OCT Methods

First we performed benchmark line rate test of different FD-OCT processing methods as follows:
LIFFT: Standard FD-OCT with linear spline interpolation;
LIFFT-C: C-FD-OCT with linear spline interpolation;
CIFFT: Standard FD-OCT with cubic spline interpolation;
CIFFT-C: C-FD-OCT with cubic spline interpolation;
NUDFT: Standard FD-OCT with NUDFT;
NUDFT-C: C-FD-OCT with NUDFT;
NUFFT: Standard FD-OCT with NUFFT; and
NUFFT-C: C-FD-OCT with NUFFT.

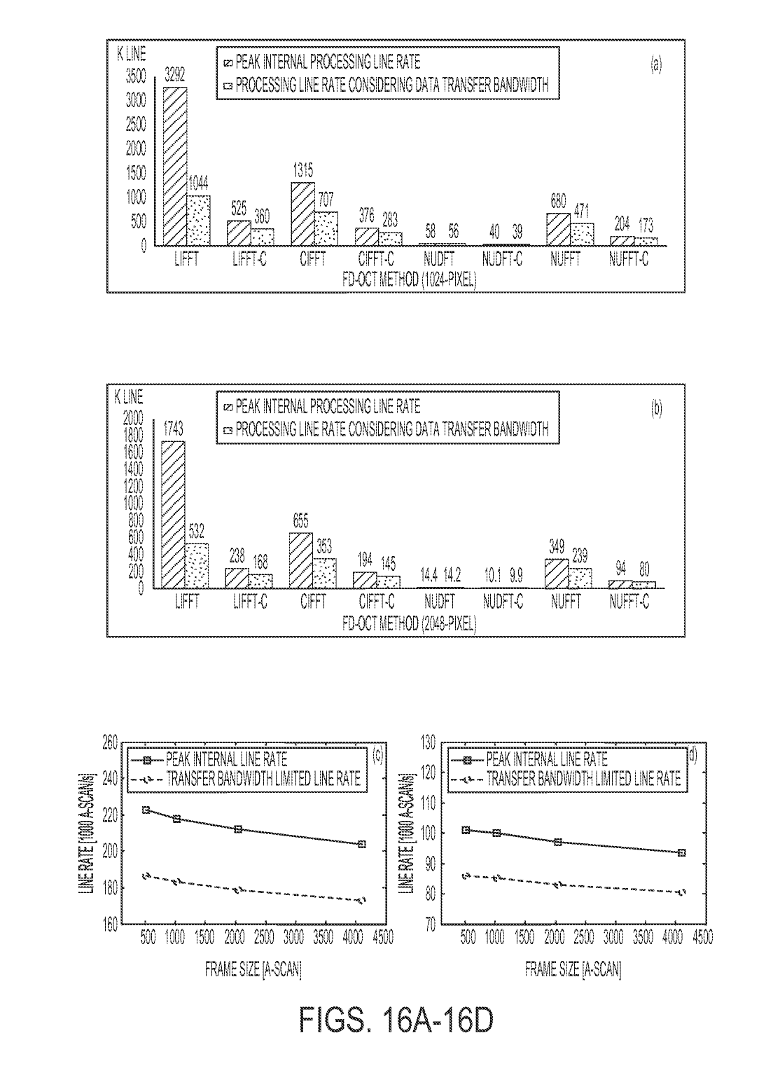

All algorithms are tested on the GTX 480 GPU with 4096 lines of both 1024-pixel spectrum and 2048-pixel spectrum. Here the 2048-pixel mode is tested as reference only and we will use the 1024-pixel mode for the real-time imaging tests in this work. For each case, both the peak internal processing line rate and the reduced line rate considering the data transfer bandwidth of PCIE x16 interface are listed in FIG. 16. The processing time is measured using CUDA functions and all CUDA threads are synchronized before the measurement. In our system, the PCIE x16 interface between the host computer and the GPU has a data transfer bandwidth of about 4.6 GByte/s for both transfer-in and transfer-out. The data size is 8.4 MByte for 4096 lines of 1024-pixel spectrum and 16.8 MByte for 4096 lines of 2048-pixel spectrum, by allocating 2 Byte for each pixel.

As in FIG. 16A, the final processing line rate for 1024-pixel C-FD-OCT with GPU-NUFFT is 173 k line/s, which is still higher than the maximum camera acquisition rate of 128 k line/s, while the GPU-NUDFT speed is relatively lower in both standard and complex FD-OCT. Also, it is notable that the processing speed of LIFFT goes up to >3,000,000 line/s (effectively >1,000,000 line/s under data transfer limit), achieving the fastest processing line rate to date to the best of our knowledge.

For C-FD-OCT, the Hilbert transform, which is implemented by two Fast Fourier transforms, has the computational complexity of ˜O(M*logM), where M is the number of lines within one frame. Therefore, the processing line rate of C-FD-OCT is also influenced by the frame size M. To verify this, we tested the relation between processing line rate of NUFFT-C mode versus frame size, as shown in FIGS. 16C and 16D. A speed decrease is observed with increasing frame size.

The zero-filling interpolation with FFT is also effective in suppressing the side-lobe effect and background noise for FD-OCT. However, the zero-filling usually requires an oversampling factor of 4 or 8, and two additional FFT, which considerably increase the array size and processing time of the data (C. Dorrer, N. Belabas, J. Likforman, and M. Joffre, “Spectral resolution and sampling issues in Fourier-transform spectral interferometry,” J. Opt. Soc. Am. B 17, 1795-1802 (2000)). From FIG. 16B, for 2048-pixel NUFFT-C mode, a peak internal processing speed of about 100,000 line/s is achieved. This is >40% faster than 70,000 line/s (1024 lines for 14.75 ms) achieved in reference (Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010)), which implemented GPU-based zero-filling interpolation for C-FD-OCT using a 480-core GPU (NVIDIA Geforce GTX 295, 2×240 core, 1.3 GHz for each core).

### Comparison of Point Spread Function and Sensitivity Roll-Off

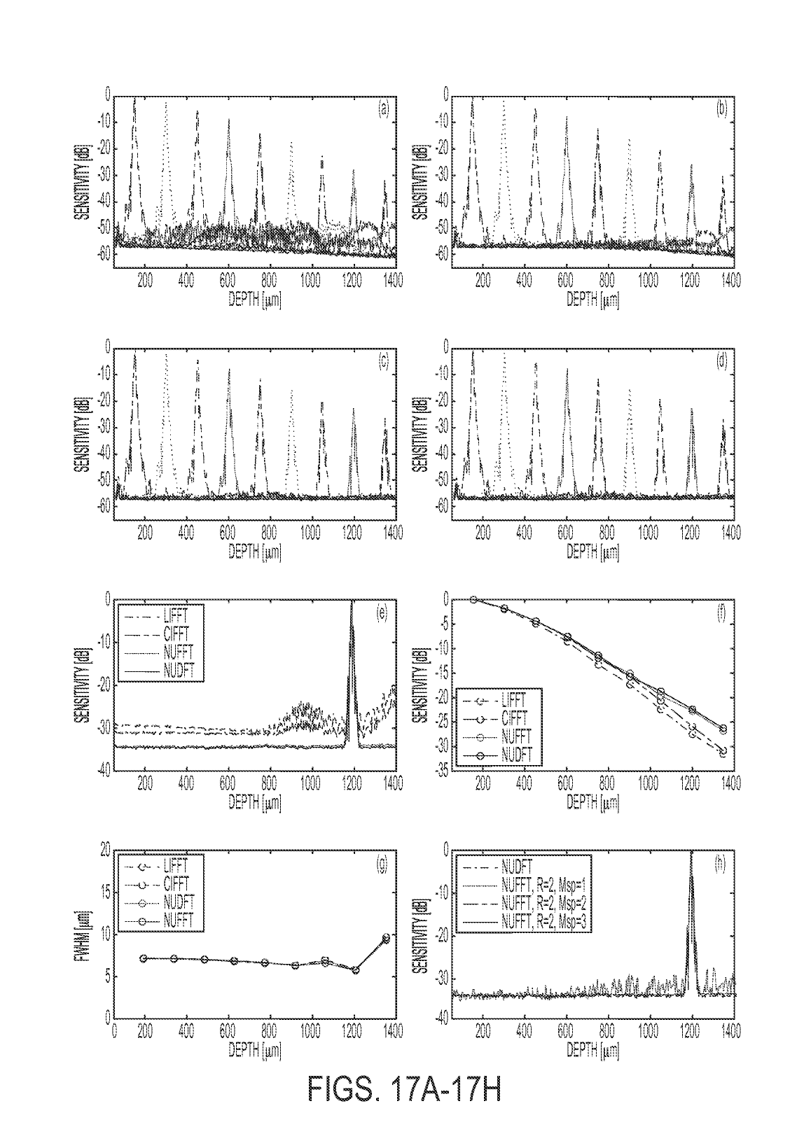

We compared the point spread function (PSF) and sensitivity roll-off of different FD-OCT processing methods, as shown in FIGS. 17A-17D, using GPU based LIFFT, CIFFT, NUDFT and NUFFT, respectively. A mirror is used as an image sample for evaluating the PSF. Here 1024 of GPU-processed 1024-pixel A-scans are averaged to present the mean noise level for the PSF in each axial position (Sébastien Vergnole, Daniel Lévesque, and Guy Lamouche, “Experimental validation of an optimized signal processing method to handle non-linearity in swept-source optical coherence tomography,” Opt. Express 18, 10446-10461 (2010)). From FIG. 17A, it is noticed that using the LIFFT method introduces significant background level and side-lobes around the signal peak. The side-lobes tend to be broad and extend to their neighboring peaks, which results in a significant degradation of the OCT image. When CIFFT is used instead, as shown in FIG. 17B, the side-lobes are suppressed in the shallow image depth, but still considerably high in deeper depth. FIGS. 17C and 17D, which utilized NUDFT and NUFFT, respectively, show significant suppression of side lobes over the whole image depth. FIG. 17E presents an individual PSF at a certain depth close to the imaging depth limit (intensity of each A-scan is normalized). Both LIFFT and CIFFT have large side-lobes, while both NUDFT and NUFFT have flat background and no noticeable side-lobes, which also indicate a higher local SNR at deeper axial positions. The measured sensitivity roll-off is summarized in FIG. 17F. All methods have a very close sensitivity level at shallow image depth <400 μm, while the interpolation based methods presents faster roll-off rate as axial position is increased. Here the sensitivity roll-off of LIFFT and CIFFT can be further improved by deconvolution of the linear/cubic interpolation kernel, and the result would be closer to NUDFT and NUFFT (Sébastien Vergnole, Daniel Lévesque, and Guy Lamouche, “Experimental validation of an optimized signal processing method to handle non-linearity in swept-source optical coherence tomography,” Opt. Express 18, 10446-10461 (2010), http://www.opticsinfobase.org/abstract.cfm?uri=oe-18-10-10446; D. Hillmann, G. Huttmann, and P. Koch, “Using nonequispaced fast Fourier transformation to process optical coherence tomography signals,” Proc. SPIE 7372, 73720R (2009)). It is also notable from FIGS. 17E and 17F that the NUFFT method exhibits negligible difference compared to the more time-consuming NUDFT, indicating a very close and reliable approximation. The full width at half maximum (FWHM) values of individual A-scans processed by different methods are presented in FIG. 17G, which indicates very close axial resolution for all methods.

FIG. 17H presents the processing result of a certain A-scan using NUFFT with R=2 and different from 1 to 3. Here R is set to 2 for the convenience of applying GPU-based FFT functions (for length of 2^{N}). From FIG. 17H, it can be noticed that for Mₛₚ≧2, the NUFFT result is close enough to NUDFT result, therefore Mₛₚ=2 is selected to decrease the computational load.

### Comparison of Real-Time Image Quality

We compared the real-time image quality of GPU-accelerated C-FD-OCT using different processing methods. Here a multi-layered polymer phantom is used as a sample. In the scanning protocol, each frame consists of 4296 A-scans in acquisition, but the first 200 lines are disposed before processing, since they are within the fly-back period of the galvanometer. Therefore each frame-size is 4096 pixel (lateral)×1024 pixel (axial).

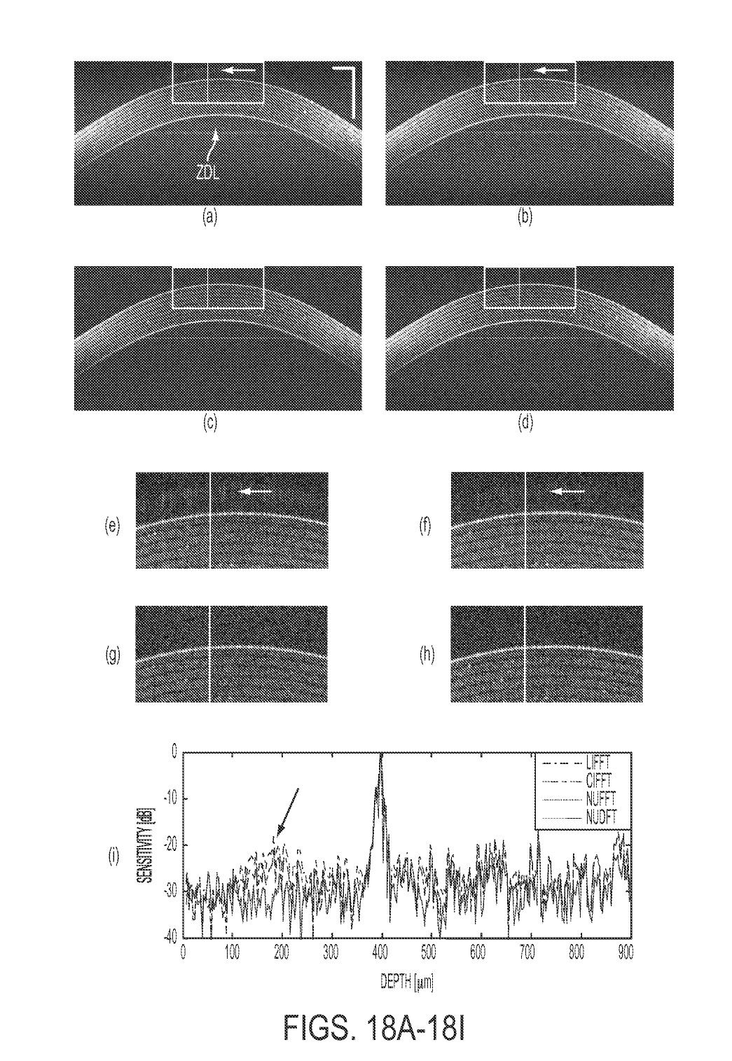

First, a single frame is captured and GPU-processed using different methods, shown in FIG. 18. The red arrows in FIGS. 18A and 16B indicate the ghost image due to the side-lobes of the reflective surface at a deeper image depth relative to the zero delay line (ZDL). The red lines correspond to the same A-scan position extracted from each image for comparison and shown collectively in (i). The resulting LIFFT/CIFFT images exhibit side-lobes in the order of 10/5 dB high compared to NUDFT/NUFFT images, as indicated by the blue arrow in FIG. 181.

Then we screen-captured the real-time displayed scenarios using different GPU-accelerated C-FD-OCT, shown in Media 1 to 4. The image frames are rescaled to 1024 pixel (lateral)×512 pixel (axial) to accommodate the monitor display. LIFFT/CIFFT/NUFFT modes are running at 29.8 fps, corresponding to a camera-limited line rate of 122 k line/s, while the NUDFT mode is GPU-limited to 9.3 fps (38 k line/s). As shown in both FIG. 18 and the corresponding movies, in LIFFT/CIFFT modes, the ghost image is evident when the phantom surface moves further away from the ZDL. However, there is no evidence of ghost images in NUDFT/NUFFT modes wherever the surface is placed.

From these results, it is clear that the GPU-NUFFT method is a very close approximation of GPU-NUDFT while offering much higher processing speed. GPU-NUFFT can be achieved at a comparable processing speed to GPU-CIFFT and is immune to interpolation error-caused ghost images.

### In Vivo Human Finger Imaging Using GPU-NUFFT Based C-FD-OCT

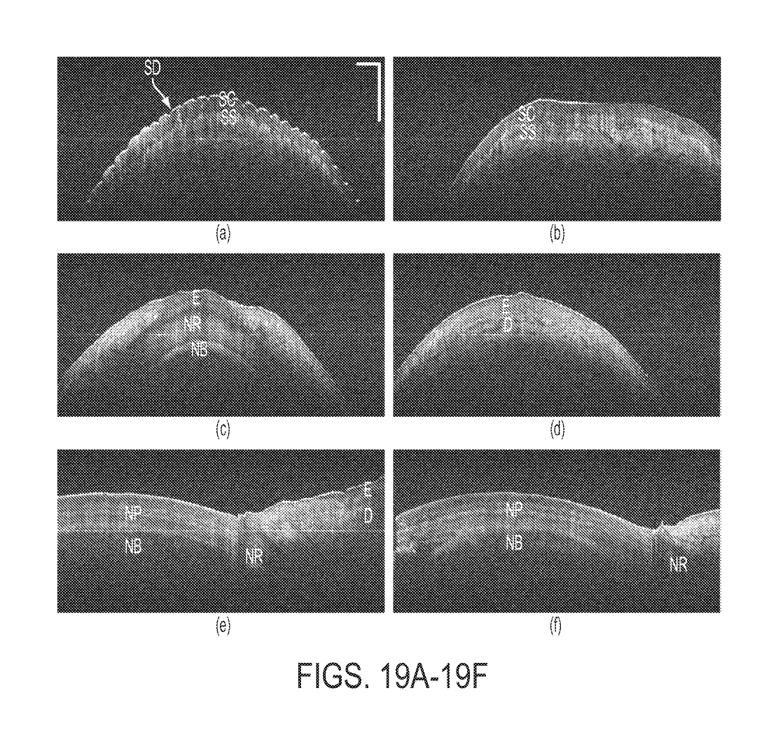

Finally, we conducted the in vivo human finger imaging using GPU-NUFFT-based C-FD-OCT, displayed at 29.8 fps with original frame size of 4096 pixel (lateral)×1024 pixel (axial). FIGS. 19A and 19B present the coronal scans of the fingertip and palm, where the epithelial structures such as sweat duct (SD), stratum corneum (SC) and stratum spinosum (SS) are clearly distinguishable. FIGS. 19C and 19D present the coronal scans of the finger nail fold region, showing the major dermatologic structures such as epidermis (E), dermis (D), nail bed (NB), and nail root (NR), as well as in the sagittal scans in FIGS. 19E and 19F. The real-time display for each figure is captured as Media 5 to 9, at 1024 pixel (lateral)×512 pixel (axial). Compared to standard FD-OCT, the GPU-NUFFT C-FD-OCT image is free of conjugate artifact, DC noise, and autocorrelation noise. These noises are problematical to remove in standard FD-OCT. Moreover, due to the implementation of the complex OCT processing, the image depth is effectively doubled, with the highest SNR region in the zero delay point. Such ultra-high-speed, real-time C-FD-OCT could be highly useful for microsurgical guidance and intervention applications.

### Conclusion

In this example, we implemented and successfully demonstrated the FGG-based NUFFT on the GPU architecture for online signal processing in a general FD-OCT system. The Vandermonde matrix-based NUDFT as well as the linear/cubic InFFT methods were also implemented on GPU as comparisons of image quality and processing speed. GPU-NUFFT provides an accurate approximation to GPU-NUDFT in terms of image quality while offering >10 times higher processing speed. Compared to the GPU-InFFT methods, GPU-NUFFT has better sensitivity roll-off, a higher local signal-to-noise ratio, and is immune to the side-lobe artifacts caused by interpolation error. Using a high speed CMOS line-scan camera, we demonstrated the real-time processing and display of GPU-NUFFT-based C-FD-OCT at a camera-limited speed of 122 k line/s (1024 pixel/A-scan). The GPU processing speed can be increased even higher by implementing a multiple-GPU architecture using more than one GPU in parallel.

### Example 3

High speed Fourier domain OCT (FD-OCT) has been proposed as a new method of microsurgical intervention. However, conventional FD-OCT systems suffer from spatially reversed complex-conjugate ghost images that could severely misguide surgeons. As a solution, complex OCT has been proposed which removes the complex-conjugate image by applying a phase modulation on interferogram frames (Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt., 45, 1861-1865 (2006)). Due to its complexity, the signal processing of complex OCT takes several times longer than the standard OCT. Thus, complex OCT images are usually “captured and saved” and post-processed, which is not ideal for microsurgical intervention applications. In this example, we implemented an ultra-high-speed, complex OCT system for surgical intervention applications using a graphics processing unit (GPU) that performs real-time signal processing and display up to an effective line speed of 244,000 A-scan/s.

### System Schematic and Signal Processing

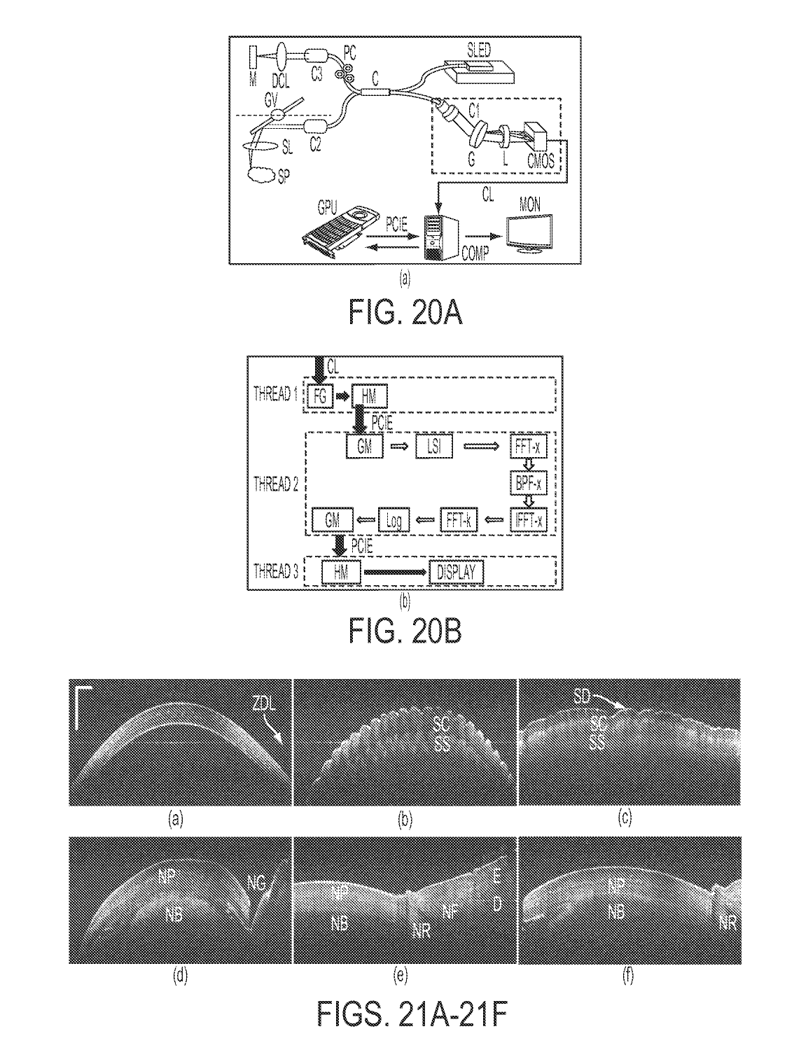

The system is schematically shown as FIG. 20A. A 12-bit CMOS camera (Sprint spL2048-140k, Basler AG, Germany) is used in the OCT spectrometer. A selected section of 1024 pixels of the camera is used to increase the line scan rate to 256,000 line/s, with a minimum 3.9 μs line period and 2.6 μs integration time. A superluminescent diode (SLED) (center λ=825 nm, Δλ=70 nm, Superlum, Ireland) was used as a light source, which gives an axial resolution of approximately 5.5 μm in air/4.1 μm in tissue. The transversal resolution was approximately 20 μm, assuming Gaussian beam profile.

A phase modulation φ(x)=βx is applied to each B-scan's 2D interferogram frame s(k,x) by slightly displacing the probe beam off the galvanometer's pivoting point (B. Baumann, M. Pircher, E. Götzinger and C. K. Hitzenberger, “Full range complex spectral domain optical coherence tomography without additional phase shifters,” Opt. Express, 15, 13375-13387 (2007)). The x indicates A-scan index in each B-scan and k presents the wavenumber index in each A-scan. By applying Fourier transform along x direction, the following equation can be obtained (Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt., 45, 1861-1865 (2006)):

F_{x→u}[S(k,x)]=|Eᵣ(k)|²δ(u)+Γᵤ{F_{x→u}[Eₛ(k,x)]}

+F_{x→u}[E*ₛ(k,x)Eᵣ(k)] [symbol] δ(u+β)+F_{x→u}[Eₛ(k,x)E*ᵣ(k)] [symbol] δ(u−β) (3.1)

where Eᵣ(k,x) and Eᵣ(k) are the electrical fields from the sample and reference arms, respectively. Γᵤ{ } is the correlation operator. The first three terms on the right hand of Eq. (3.1) present the DC noise, autocorrelation noise, and complex-conjugate noise, respectively. The last term can be filtered out by a proper band pass filter in the u domain and then back to x domain by applying an inverse Fourier transform along the x direction. Finally, the OCT image is obtained by Fourier transform in the k domain and logarithmically scaled for display as in standard FD-OCT.

The above signal processing was fully implemented using NVIDIA's CUDA language on a GPU (NVIDIA GeForce GTX 480) with 480 stream processors (1.4 GHz clock rate) and 1.5 Gigabyte graphics memory (K. Zhang and J. U. Kang, “Real-time 4D signal processing and visualization using graphics processing unit on a regular nonlinear-k Fourier-domain OCT system,” Opt. Express, 18, 11772-11784 (2010)). The developed software contains three synchronized threads for raw data acquisition, GPU processing, and display respectively. For each B-scan, 8592 lines are acquired as one frame but the first 400 lines are automatically disposed, since it contains the fly-back period of the galvanometer. The remaining 8192 lines are transferred-in and processed by the GPU at a frame rate of 29.8 Hz, which corresponds to an effective line speed of 244,000 A-scan/s. The total time for GPU processing, including data transfer-in and transfer-out, was measured to be about 25 ms, which calculates to be a processing speed of 328,000 A-scan/s for 1024 pixel complex OCT.

### Results and Analysis

The real-time displayed images are directly captured from the screen and shown in FIGS. 21A-21F. Each image consists of 8192 A-scans with 1024 pixel/A-scans, and corresponds to image size of 15 mm (lateral) by 3 mm (depth). The anatomic structures of finger print and nail regions are clearly distinguishable from FIGS. 21B-21F. Compared to standard FD-OCTs, the image is free of conjugate artifacts, DC noise, and autocorrelation noise. These are all difficult noises to remove in standard FD-OCT. Moreover, the image depth is effectively doubled, with the highest SNR region in the zero delay point. Such ultra-high-speed, real-time complex OCT can be highly useful for microsurgical guidance and intervention applications, for example.

### Conclusions

In this example, we implemented an ultra-high-speed, complex OCT system using a graphics processing unit and achieved real-time signal processing display up to an effective line speed of 244,000 A-scan/s. Some embodiments of this ultra-high-speed, real-time complex OCT system can be implemented for microsurgical guidance and intervention applications.

### Example 4

Microsurgeries require both physical and optical access to limited space in order to perform tasks on delicate tissue. The ability to view critical parts of the surgical region and work within micron proximity to the fragile tissue surface requires excellent visibility and precise instrument manipulation. The surgeon needs to function within the limits of human sensory and motion capability to visualize targets, steadily guide microsurgical tools and execute all surgical targets. These directed surgical maneuvers must occur intraoperatively with minimization of surgical risk and expeditious resolution of complications. Conventionally, visualization during the operation is realized by surgical microscopes, which limits the surgeon's field of view (FOV) to the en face scope (K. Zhang, W. Wang, J. Han and J. U. Kang, “A surface topology and motion compensation system for microsurgery guidance and intervention based on common-path optical coherence tomography,” IEEE Trans. Biomed. Eng. 56, 2318-2321 (2009)), with limited depth perception of micro-structures and tissue planes.

As a noninvasive imaging modality, optical coherence tomography (OCT) is capable of cross-sectional micrometer-resolution images and a complete 3D data set could be obtained by 2D scanning of the targeted region. Compared to other modalities used in image-guided surgical intervention such as MRI, CT, and ultrasound, OCT is highly suitable for applications in microsurgical guidance (K. Zhang, W. Wang, J. Han and J. U. Kang, “A surface topology and motion compensation system for microsurgery guidance and intervention based on common-path optical coherence tomography,” IEEE Trans. Biomed. Eng. 56, 2318-2321 (2009); Y. K. Tao, J. P. Ehlers, C. A. Toth, and J. A. Izatt, “Intraoperative spectral domain optical coherence tomography for vitreoretinal surgery,” Opt. Lett. 35, 3315-3317 (2010); Stephen A. Boppart, Mark E. Brezinski and James G. Fujimoto, “Surgical Guidance and Intervention,” in Handbook of Optical Coherence Tomography, B. E. Bouma and G. J Tearney, ed. (Marcel Dekker, New York, N.Y., 2001)). For clinical intraoperative purposes, a FD-OCT system should be capable of ultrahigh-speed, raw data acquisition as well as matching-speed data processing and visualization. In recent years, the A-scan acquisition rate of FD-OCT systems has generally reached multi-hundred-of-thousand line/second level (W-Y. Oh, B. J. Vakoc, M. Shishkov, G. J. Tearney, and B. E. Bouma, “>400 kHz repetition rate wavelength-swept laser and application to high-speed optical frequency domain imaging,” Opt. Lett. 35, 2919-2921 (2010); B. Potsaid, B. Baumann, D. Huang, S. Barry, A. E. Cable, J. S. Schuman, J. S. Duker, and J. G. Fujimoto, “Ultrahigh speed 1050 nm swept source/Fourier domain OCT retinal and anterior segment imaging at 100,000 to 400,000 axial scans per second,” Opt. Express 18, 20029-20048 (2010), http://www.opticsinfobase.org/oe/abstract.cfm→URI=oe-18-19-20029) and approaching the multi-million line/second level (W. Wieser, B. R. Biedermann, T. Klein, C. M. Eigenwillig, and R. Huber, “Multi-Megahertz OCT: High quality 3D imaging at 20 million A-scans and 4.5 GVoxels per second,” Opt. Express 18, 14685-14704 (2010), http://www.opticsinfobase.org/oe/abstract.cfm?URI=oe-18-14-14685; T. Bonin, G. Franke, M. Hagen-Eggert, P. Koch, and G. Hüttmann, “In vivo Fourier-domain full-field OCT of the human retina with 1.5 million A-lines/s,” Opt. Lett. 35, 3432-3434 (2010)). Recent developments of graphics processing unit (GPU) accelerated FD-OCT processing and visualization have enabled real-time 4D (3D+time) imaging at the speed up to 10 volume/second (K. Zhang and J. U. Kang, “Real-time 4D signal processing and visualization using graphics processing unit on a regular nonlinear-k Fourier-domain OCT system,” Opt. Express 18, 11772-11784 (2010), http://wwww.opticsinfobase.org/abstract.cfm?URI=oe-18-11-11772; M. Sylwestrzak, M. Szkulmowski, D. Szlag and P. Targowski, “Real-time imaging for Spectral Optical Coherence Tomography with massively parallel data processing,” Photonics Letters of Poland, 2, 137-139 (2010); J. Probst, D. Hillmann, E. Lankenau, C. Winter, S. Oelckers, P. Koch, G. Hüttmann, “Optical coherence tomography with online visualization of more than seven rendered volumes per second,” J. Biomed. Opt. 15, 026014 (2010)). However, these systems all work in the standard mode, and therefore suffer from spatially reversed complex-conjugate ghost images. During intraoperative imaging, for example, when long-shaft surgical tools are used, such ghost images could severely misguide the surgeons. As a solution according to an embodiment of the current invention, a GPU-accelerated full-range FD-OCT has been utilized and real-time B-scan images were demonstrated with effective complex-conjugate suppression and doubled imaging range (K. Zhang and J. U. Kang, “Graphics processing unit accelerated non-uniform fast Fourier transform for ultrahigh-speed, real-time Fourier-domain OCT,” Opt. Express 18, 23472-23487 (2010), http://www.opticsinfobase.org/abstract.cfm?URI=oe-18-22-23472; Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010)).

In this example according to an embodiment of the current invention, we implemented a real-time, 4D full-range complex-conjugate-free FD-OCT based on a dual-GPU architecture, where one GPU was dedicated to the FD-OCT data processing while the second one was used for the volume rendering and display. GPU-based, non-uniform, fast Fourier transform (NUFFT) (Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010)) is also implemented to suppress the side lobes of the point spread function and to improve the image quality. With a 128,000 A-scan/second OCT engine, we obtained 5 volumes/second 3D imaging and display. We have demonstrated the real-time visualization capability of the system by performing a micro-manipulation process using a vitro-retinal surgical tool and a phantom model. Multiple-volume rendering of the same 3D data set was performed and displayed with different view angles. This technology can provide the surgeons with comprehensive intraoperative imaging of the microsurgical region which could improve the accuracy and safety of microsurgical procedures.

### System Configuration and Data Processing

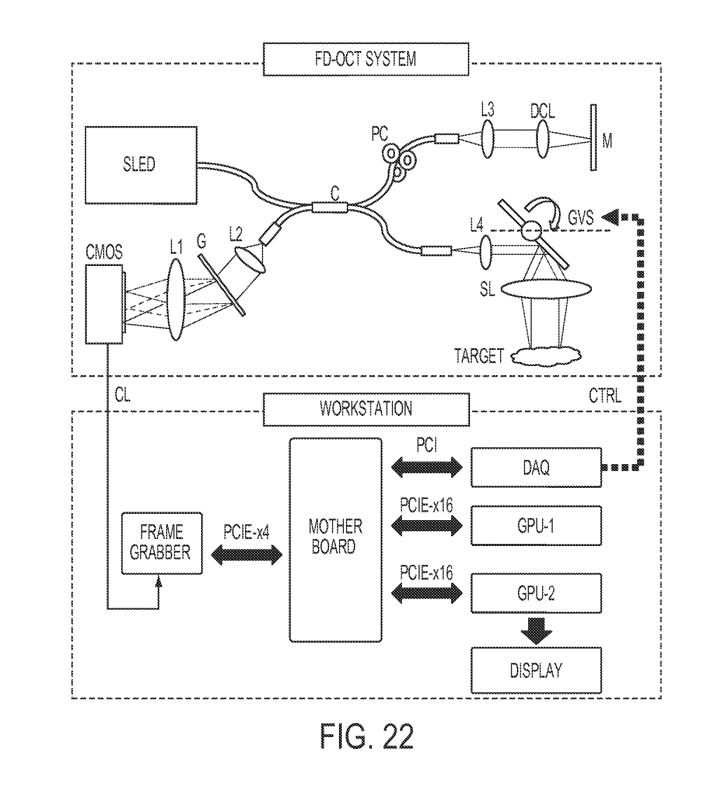

The system configuration is shown in FIG. 22. In the FD-OCT system section, a 12-bit dual-line CMOS line-scan camera (Sprint spL2048-140k, Basler AG, Germany) is used as the detector of the OCT spectrometer. A superluminescence diode (SLED) (λ₀=825 nm, Δλ=70 nm, Superlum, Ireland) is used as the light source, giving a theoretical axial resolution of 5.5 μm in air. The transversal resolution was approximately 40 μm assuming Gaussian beam profile. The CMOS camera is set to operate at the 1024-pixel mode by selecting the area-of-interest (AOI). The minimum line period is camera-limited to 7.8 μs, corresponding to a maximum line rate of 128 k A-scan/s, and the exposure time is 6.5 μs. The beam scanning was implemented by a pair of high speed galvanometer mirrors controlled by a function generator and a data acquisition (DAQ) card. The raw data acquisition is performed using a high speed frame grabber with camera link interface. To realize the full-range, complex OCT mode, a phase modulation is applied to each B-scan's 2D interferogram frame by slightly displacing the probe beam off the first galvanometer's pivoting point (only the first galvanometer is illustrated in FIG. 22) (K. Zhang and J. U. Kang, “Graphics processing unit accelerated non-uniform fast Fourier transform for ultrahigh-speed, real-time Fourier-domain OCT,” Opt. Express 18, 23472-23487 (2010), http://www.opticsinfobase.org/abstract.cfm?URI=oe-18-22-23472; Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010); L B. Baumann, M. Pircher, E. Götzinger and C. K. Hitzenberger, “Full range complex spectral domain optical coherence tomography without additional phase shifters,” Opt. Express 15, 13375-13387 (2007), http://www.opticsinfobase.org/abstract.cfm?URI=oe-15-20-13375).

A quad-core Dell T7500 workstation was used to host the frame grabber (PCIE-x4 interface), DAQ card (PCI interface), GPU-1 and GPU-2 (both PCIE-x16 interface), all on the same mother board. GPU-1 (NVIDIA GeForce GTX 580) with 512 stream processors, 1.59 GHz processor clock and 1.5 GBytes graphics memory is dedicated for raw data processing of B-scan frames. GPU-2 (NVIDIA GeForce GTS 450) with 192 stream processors, 1.76 GHz processor clock and 1.0 GBytes graphics memory is dedicated for the volume rendering and display of the complete C-scan data processed by GPU-1. The GPU is programmed through NVIDIA's Compute Unified Device Architecture (CUDA) technology (NVIDIA, “NVIDIA CUDA C Programming Guide Version 3.2,” (2010)). The software is developed under the Microsoft Visual C++ environment with National Instrument's IMAQ Win32 APIs.

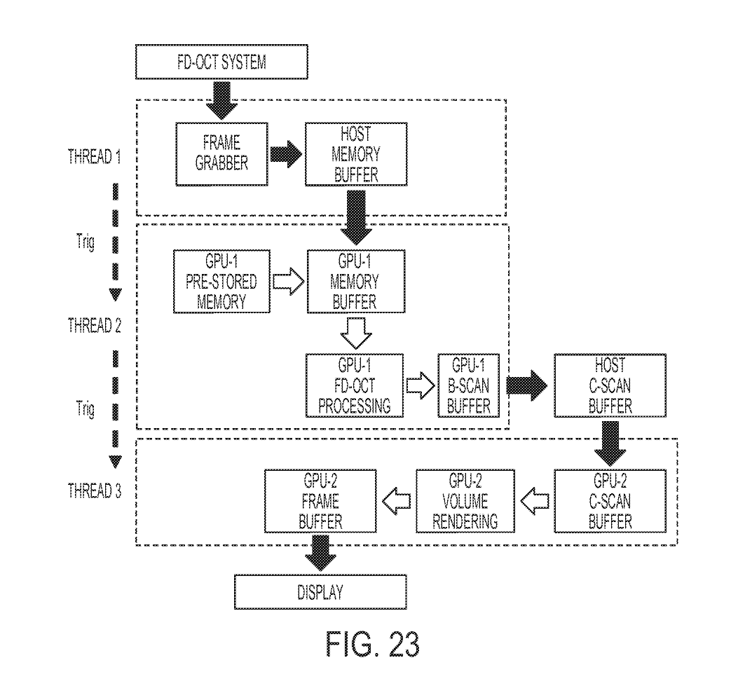

The signal processing flow chart of the dual-GPU architecture is illustrated in FIG. 23, where three major threads are used for the FD-OCT system raw data acquisition (Thread 1), the GPU accelerated FD-OCT data processing (Thread 2), and the GPU based volume rendering (Thread 3). The three threads synchronize in the pipeline mode, where Thread 1 triggers Thread 2 for every B-scan and Thread 2 triggers Thread 3 for every complete C-scan, as indicated by the dashed arrows. The solid arrows describe the main data stream and the hollow arrows indicate the internal data flow of the GPU. Since the CUDA technology currently does not support direct data transfer between GPU memories, a C-Scan buffer is placed in the host memory for the data relay.

Compared to previously reported systems, this dual-GPU architecture separates the computing task of the signal processing and the visualization into different GPUs, which can provide the following advantages:

(1) Assigning different computing tasks to different GPUs makes the entire system more stable and consistent. For the real-time 4D imaging mode, the volume rendering is only conducted when a complete C-scan is ready, while B-scan frame processing is running continuously. Therefore, if the signal processing and the visualization are performed on the same GPU, competition for GPU resource will happen when the volume rendering starts while the B-scan processing is still ongoing, which could result in instability for both tasks.

(2) It will be more convenient to enhance the system performance from the software engineering perspective. For example, the A-scan processing could be further accelerated and the point spread function (PSF) could be refined by improving the algorithm with GPU-1, while more complex 3D image processing tasks such as segmentation or target tracking can be added to GPU-2.

In our experiment, the B-scan size is set to 256 A-scans with 1024 pixel each. Using the GPU based NUFFT algorithm, GPU-1 achieved a peak A-scan processing rate of 252,000 lines/s and an effective rate of 186,000 lines/s when the host-device data transferring bandwidth of PCIE-x16 interface was considered, which is higher than the camera's acquisition line rate. The NUFFT method was effective in suppressing the side lobes of the PSF and in improving the image quality, especially when surgical tools with metallic surface are used. The C-scan size is set to 100 B-scans, resulting in 256×100×1024 voxels (effectively 250×98×1024 voxels after removing of edge pixels due to fly-back time of galvanometers), and 5 volumes/second. It takes GPU-2 about 8 ms to render one 2D image with 512×512 pixel from this 3D data set using the ray-casting algorithm (K. Zhang and J. U. Kang, “Real-time 4D signal processing and visualization using graphics processing unit on a regular nonlinear-k Fourier-domain OCT system,” Opt. Express 18, 11772-11784 (2010), http://wvvw.opticsinfobase.org/abstract.cfm?URI=oe-18-11-11772).

### Results and Discussion

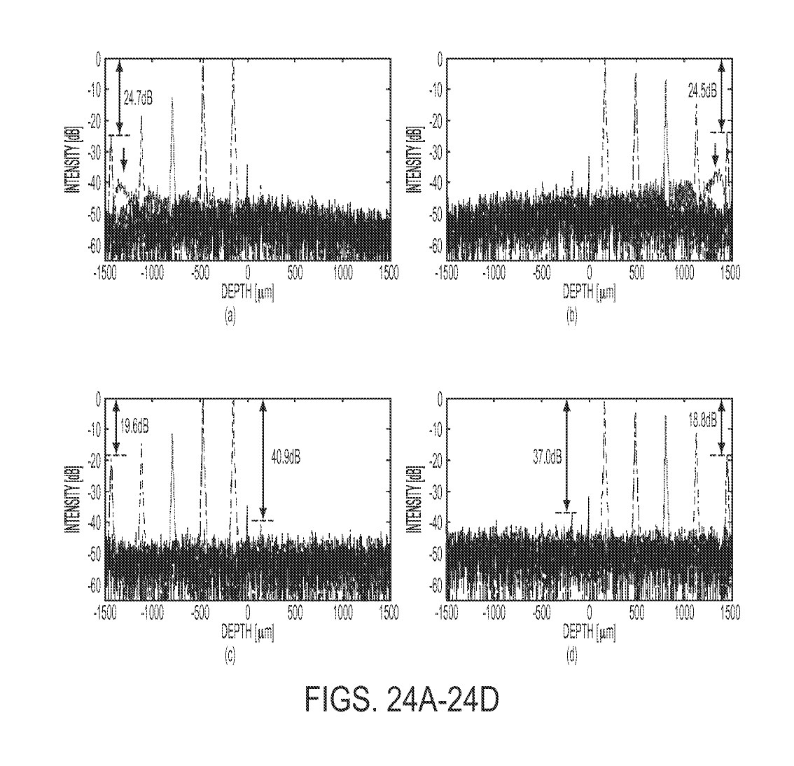

First, we tested the optical performance of the system using a mirror as the target. At both sides of the zero-delay, PSFs at different positions are processed as A-scans using linear interpolation with FFT (FIGS. 24A and 24B) and NUFFT (FIGS. 24C and 24D), respectively. As one can see, using NUFFT processing, the system obtained a sensitivity fall-off of 19.6 dB from position near zero-delay to the negative edge, and 18.8 dB to the positive edge, which is lower than using linear interpolation with FFT (24.7 dB to the negative edge and 24.5 dB to the positive edge). Moreover, compared to the linear interpolation method, NUFFT obtained a constant background noise level over the whole A-scan range. The blue arrows in FIGS. 24A and 24B indicates side lobes in the PSFs near both positive and negative edges as a result of interpolation error. By applying a proper super-Gaussian filter to the modified Hilbert transform (Y. Watanabe, S. Maeno, K. Aoshima, H. Hasegawa, and H. Koseki, “Real-time processing for full-range Fourier-domain optical-coherence tomography with zero-filling interpolation using multiple graphic processing units,” Appl. Opt. 49, 4756-4762 (2010)), the conjugate suppression ratios of 37.0 dB and 40.9 dB are obtained respectively at the positive and negative sides near zero-delay. Therefore, by applying NUFFT in GPU-1, we can obtain high quality, low noise image sets for later volume rendering in GPU-2.

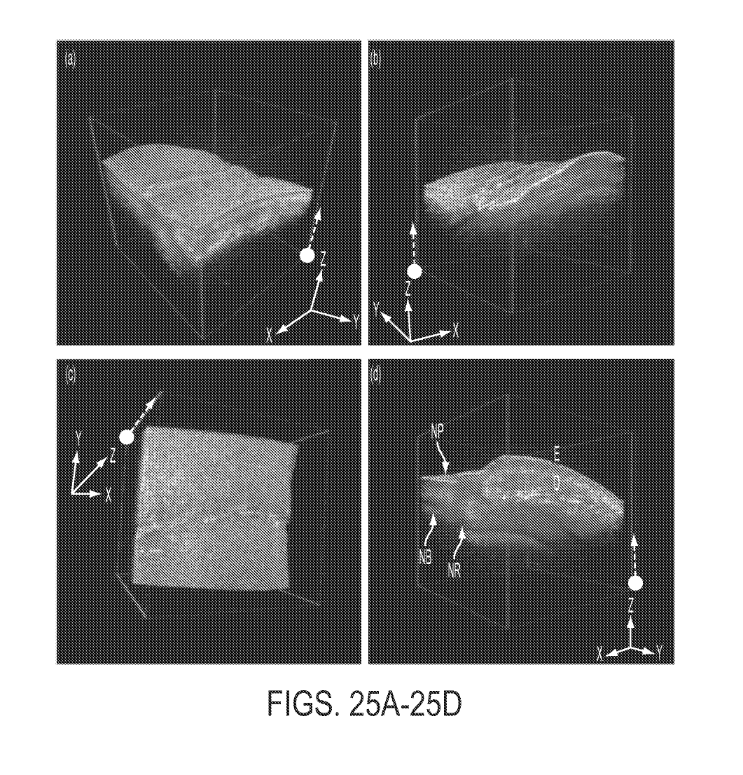

Then, the in vivo human finger imaging is conducted to test the imaging capability on biological tissue. The scanning range is 3.5 mm (X)×3.5 mm (Y) lateral and 3 mm (Z) for the axial full-range. The finger nail fold region is imaged as FIG. 25 (screen captured as Media 1 at 5 frame/second), where 4 frames are rendered from the same 3D data set with different view angles. The green arrows/dots on each 2D frame correspond to the same edges/vertexes of the rendering volume frame, giving comprehensive information of the image volume. As noted in FIG. 25D, the major dermatologic structures such as epidermis (E), dermis (D), nail plate (NP), nail root (NR) and nail bed (NB) are clearly distinguishable.

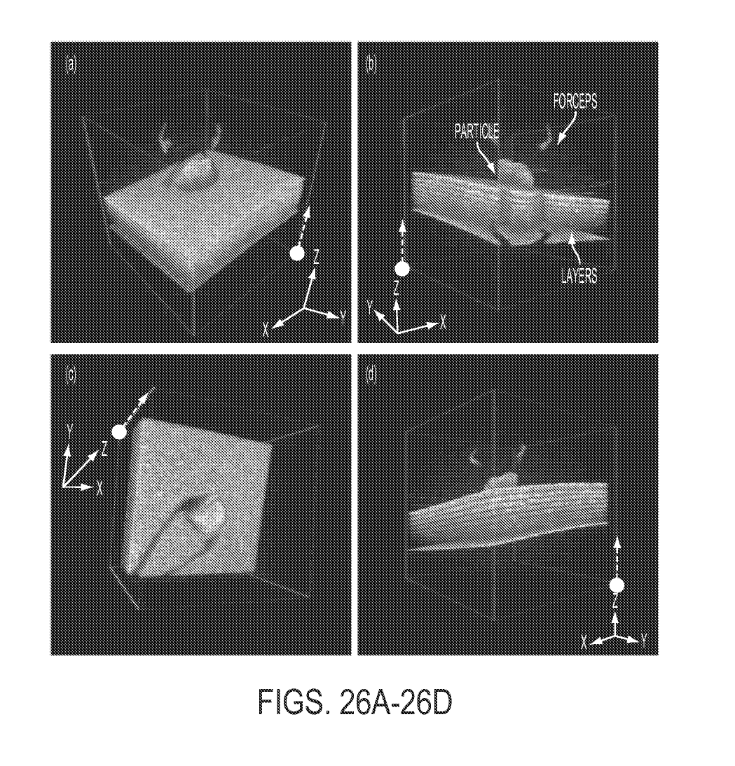

Finally, we performed a real-time 4D full-range FD-OCT guided micro-manipulation using a phantom model and a vitreoretinal surgical forceps, with the same scanning protocol as FIG. 26. As shown in FIG. 26, a sub-millimeter particle is attached on a multi-layered surface made of polymer layers. The mini-surgical forceps was used to pick up the particle from the surface without touching the surface. As shown in Media 2, multiple volume rendering of the same 3D date set were displayed with different view angles to allow accurate monitoring of the micro-procedure, and the tool-to-target spatial relation was clearly demonstrated in real-time. Compared to the conventional surgical microscope, this technology can provide the surgeons with a comprehensive spatial view of the microsurgical region as well as depth perception. Therefore, some embodiments of the current invention can provide an effective intraoperative surgical guidance tool that could improve the accuracy and safety of microsurgical procedures.

### Conclusion

In this example, a real-time 4D full-range FD-OCT system is implemented based on the dual-GPUs architecture. The computing task of signal processing and visualization into different GPUs and real-time 4D imaging and display of 5 volume/second has been obtained. A real-time 4D full-range FD-OCT guided micro-manipulation is performed using a phantom model and a vitreoretinal surgical forceps. This technology can provide the surgeons with a comprehensive spatial view of the microsurgical site and can be used to guide microsurgical tools during microsurgical procedures effectively.

### Example 5

Compared to other imaging modalities such as CT, ultrasound and MRI, which have already been widely used in image-guided intervention (IGI), OCT has the disadvantage of shallower imaging penetration depth. As a solution, endoscopic OCT has been proposed for intra-body imaging (Z. Yaqoob, J. Wu, E. J. McDowell, X. Heng, and C. Yang, “Methods and application areas of endoscopic optical coherence tomography,” J. Biomed. Opt. 11, 063001 (2006)). A wide range of miniature endoscopic OCT probes have been developed to provide high resolution imaging while being flexible and integratable with medical devices such as rotary OCT imaging needles (X. Li, C. Chudoba, T. Ko, C. Pitris, and J. G. Fujimoto, “Imaging needle for optical coherence tomography,” Opt. Lett. 25, 1520-1522 (2000)) and balloon catheters (J. Xi, L. Huo, Y. Wu, M. J. Cobb, J. Ha Hwang, and X. Li, “High-resolution OCT balloon imaging catheter with astigmatism correction,” Opt. Lett. 34, 1943-1945 (2009)), paired-angle-rotation scanning (PARS) probes (J. Wu, M. Conry, C. Gu, F. Wang, Z. Yaqoob, and C. Yang, “Paired-angle-rotation scanning optical coherence tomography forward-imaging probe,” Opt. Lett. 31, 1265-1267 (2006)), polymer-based scanning cantilevers (Y. Wang, M. Bachman, G-P. Li, S. Guo, B. J. F. Wong, and Z. Chen, “Low-voltage polymer-based scanning cantilever for in vivo optical coherence tomography,” Opt. Lett. 30, 53-55 (2005)), piezoelectric scanning mirrors (K. H. Gilchrist, R. P. McNabb, J. A Izatt and S. Grego, “Piezoelectric scanning mirrors for endoscopic optical coherence tomography,” J. Micromech. Microeng. 19, 095012 (2009)), MEMS scanning mirrors (A. D. Aguirre, P. R. Hertz, Y. Chen, J. G. Fujimoto, W. Piyawattanametha, L. Fan, and M. C. Wu, “Two-axis MEMS scanning catheter for ultrahigh resolution three-dimensional and en face imaging,” Opt. Express 15, 2445-2453 (2007); K. H. Kim, B. H. Park, G. N. Maguluri, T. W. Lee, F. J. Rogomentich, M. G. Bancu, B. E. Bouma, J. F. de Boer, and J. J. Bernstein, “Two-axis magnetically-driven MEMS scanning catheter for endoscopic high-speed optical coherence tomography,” Opt. Express 15, 18130-18140 (2007)), piezoelectric (X. Liu, M. J. Cobb, Y. Chen, M. B. Kimmey, and X. Li, “Rapid-scanning forward-imaging miniature endoscope for real-time optical coherence tomography,” Opt. Lett. 29, 1763-1765 (2004)) and magnetic force-driven resonant fiber scanners (E. J. Min, J. Na, S. Y. Ryu, and B. H. Lee, “Single-body lensed-fiber scanning probe actuated by magnetic force for optical imaging,” Opt. Lett. 34, 1897-1899 (2009); E. J. Min, J. G. Shin, Y. Kim, and B. H. Lee, “Two-dimensional scanning probe driven by a solenoid-based single actuator for optical coherence tomography,” Opt. Lett. 36, 1963-1965 (2011)). With the rapid development in OCT technologies, in recent years endoscopic OCT has undergone a transition from traditional low-speed, time-domain mode to high-speed Fourier domain mode (L. Huo, J. Xi, Y. Wu, and X. Li, “Forward-viewing resonant fiber-optic scanning endoscope of appropriate scanning speed for 3D OCT imaging,” Opt. Express 18, 14375-14384 (2010); S. Moon, S-W. Lee, M. Rubinstein, B. J. F. Wong, and Z. Chen, “Semi-resonant operation of a fiber-cantilever piezotube scanner for stable optical coherence tomography endoscope imaging,” Opt. Express 18, 21183-21197 (2010)).

However, as in the regular bulky-scanner based systems, the FD-OCT imaging probes can also suffer from complex-conjugate ghost image that could severely misguide the users. For some cases, a transparent window can be used to keep the image target within one side of the zero-delay position [6], however, this method automatically sacrificed half of the image range and is not applicable for many other circumstances. In this work, we implemented the full-range, complex-conjugate-free FD-OCT with a forward-viewing miniature resonant fiber-scanning probe. A galvanometer-driven reference mirror provides a linear phase modulation to the A-scans within one frame and the simultaneous B-M-mode scanning are implemented. Inside the probe, a fiber cantilever is driven by a low-voltage magnetic transducer synchronized to the reference mirror scanning. Using a CCD line-scan camera-based spectrometer, we demonstrated real-time full-range FD-OCT imaging with doubled imaging range at 34 frame/s.

### Probe Development

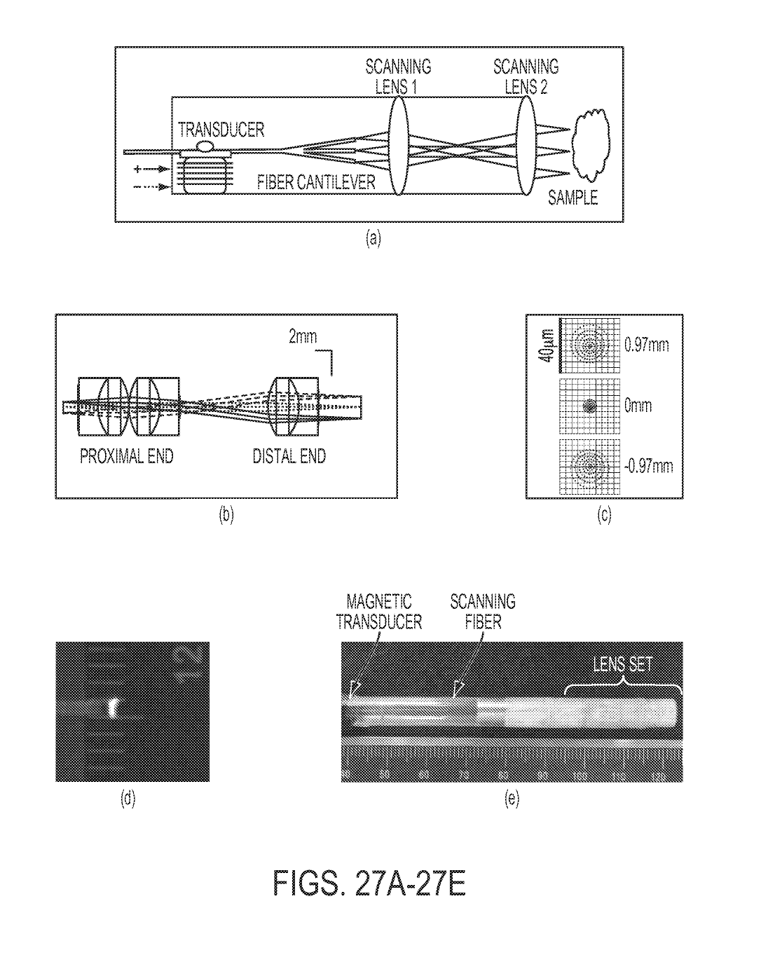

First we designed a forward-viewing miniature resonant fiber-scanning probe based on a low-voltage miniature magnetic transducer, as shown in FIG. 27A. Inside the probe, a miniature magnetic transducer with 5 mm in diameter and 2 mm in thickness is used to drive a single-mode fiber cantilever, which is attached to the diaphragm of the transducer. The fiber cantilever scans within the plane perpendicular to the diaphragm at its resonant frequency. Two scanning lenses are placed after the fiber to image the beam across the sample. The fiber tip is placed at the focal plane of scanning lens 1 so that the distal imaging plane can be located at the focal plane of scanning lens 2. This lens setup minimizes the imaging field distortion and avoids the need for the geometrical correction during the image processing stage. FIG. 27B shows the ZEMAX simulation of the scanning lens set, where we combined two achromatic lenses to form scanning lens 1 (proximal end), and used another one as scanning lens 2 (distal end). All three lenses are type AC050-008-B, 5 mm diameter, f=7.5 mm, Thorlabs, therefore a telemetric system with an approximately 1:2 magnification is formed by the three lenses. As shown in the optimized Zemax simulation in FIG. 27B, with the fiber scanning range of 1 mm, an imaging range of 1.94 mm is obtained at the scanning plane of the probe. The actual imaging N. A. is simulated to be about 0.07. The spot size is simulated by ZEMAX as in FIG. 27C, which indicates a below 30 μm over the scan range without apparent focusing distortion. In the actual system, the scanning fiber tip is angle-cleaved by ˜8° to minimize Fresnel reflection and the scanning range is set to 1 mm by adjusting the amplitude of the function generator input to the transducer, as shown in FIG. 27D. A prototype of the probe is shown in FIG. 27E, which can be further miniaturized by shortening the scanning fiber, using a smaller transducer, and using smaller scanning lenses.

### System Configuration

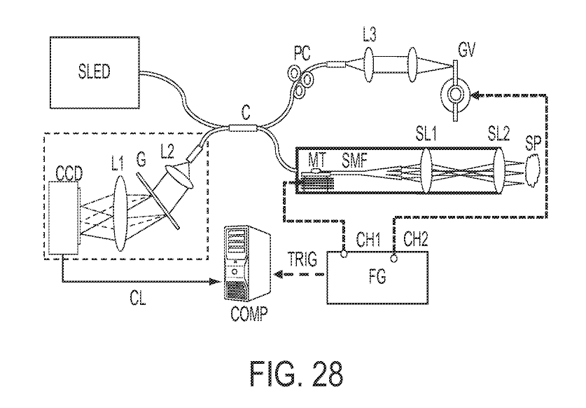

The probe is integrated into a spectrometer-based FD-OCT system, as shown in FIG. 28. A 12-bit CCD line-scan camera (EM4, e2v, USA) performs as the linear detector of the OCT spectrometer. A superluminescence diode (SLED) (λ₀=825 nm, Δλ=70 nm, Superlum, Ireland) was used as the light source, which provided a measured axial resolution of approximately 5.5 μm in air using the common-path interferometer setup (K. Zhang, W. Wang, J. Han and J. U. Kang, “A surface topology and motion compensation system for microsurgery guidance and intervention based on common-path optical coherence tomography,” IEEE Trans. Biomed. Eng. 56, 2318-2321 (2009)). The minimum line period is camera-limited to 14.2 μs, which corresponds to a maximum line rate of 70 k A-scan/s. A quad-core Dell T7500 workstation was used to host a frame grabber (PCIe-1429, National Instruments, USA) and to implement the data processing. A galvanometer-driven mirror is placed at the end of the reference arm. The fiber-scanning probe and the reference mirror are driven by a dual channel function generator (FG) and synchronized with the frame grabber.

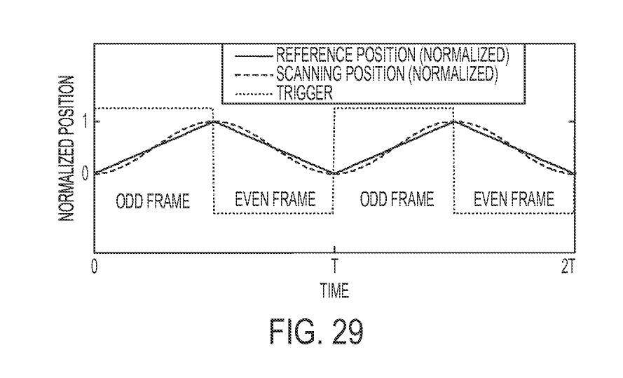

To induce a phase modulation, as in FIG. 28, a sinusoidal wave (CH1) was sent to drive the magnetic transducer and a symmetrical triangle wave (CH2) for the galvanometer mirror. The scanning position of the probe was experimentally adjusted so that it is in phase with the reference mirror position and the frame grabber triggering signal, as shown in FIG. 29. The rising and the falling slopes of the reference mirror's triangle motion applies linear phase modulation to the odd and the even image frames, respectively. To fully utilize the 70 kHz line speed of the CCD camera, the resonant frequency of the cantilever was set to ˜34 Hz by experimentally adjusting the fiber length. By setting 1024 A-scans to form each frame and scanning frequency to 34 Hz, the imaging speed was 34.8 kHz for single-way scanning and 69.6 kHz for dual-way scanning. The final fiber length was around 55 mm, which can be made shorter by putting a weight on the cantilever tip (L. Huo, J. Xi, Y. Wu, and X. Li, “Forward-viewing resonant fiber-optic scanning endoscope of appropriate scanning speed for 3D OCT imaging,” Opt. Express 18, 14375-14384 (2010)).

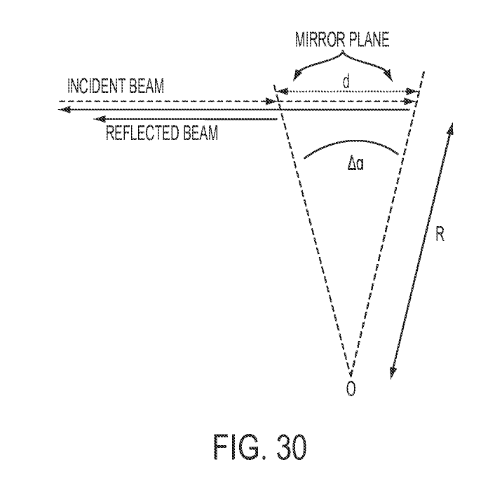

FIG. 30 illustrates the galvanometer-driven reference mirror induced phase modulation; using the small-angle approximation, the displacement of the reference position is d=RΔα, where R is the distance from the beam spot to the pivoting point O. Δα is the scanning angle. Then the inter-A-scan phase shift is given by,

$$Φ = 2 π * 2 * \frac{d}{{λ}_{0}} * \frac{1}{N} = \frac{4 π R Δα}{N {λ}_{0}} , \qquad ( 51 )$$

and λ₀ is the central wavelength of the light source. N is the number of A-scans within each frame. In our setup, with λ₀=825 nm, we set R=3 mm, Δα=2°, and N=1024.

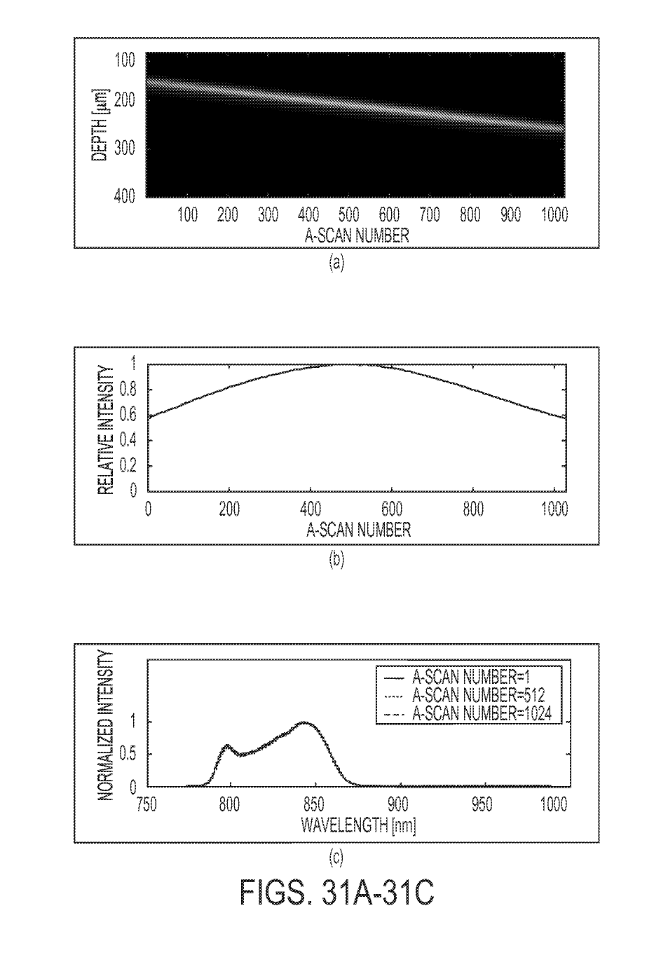

FIG. 31A shows a M-scan frame of 1024 A-scans obtained by keeping the probe focused on a fixed mirror, from which we deduced the actual reference displacement value of d=109 μm. This corresponds to an experimental phase shift of Φ=1.62, which is very close to the optimal phase shift of ir/2 (Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt. 45, 1861-1865 (2006)). With a minimum line period of 14.2 μs, a maximum carrier frequency of 11.4 kHz was obtained, which corresponds to an axial motion speed of 7.3 mm/s (B. Baumann, M. Pircher, E. Götzinger, and C. K. Hitzenberger, “Full range complex spectral domain optical coherence tomography without additional phase shifters,” Opt. Express 15, 13375-13387 (2007)). FIG. 31B presents the modulation in the amplitude of the reference within each image frame. FIG. 31C shows normalized reference spectrums corresponding to three different A-scans within each frame. As one can see, the amplitude of the reference at the edges of the image frame is about 60% of that in the middle, while the spectral shape remains relatively unchanged and the intensity modulation is compensated accordingly during the imaging processing. The phase modulation can also be implemented by a piezoelectric stage-driven mirror (Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt. 45, 1861-1865 (2006)), a fiber stretcher (S. Vergnole, G. Lamouche, and M. L. Dufour, “Artifact removal in Fourier-domain optical coherence tomography with a piezoelectric fiber stretcher,” Opt. Left. 33, 732-734 (2008)) or an electro-optic phase modulator (EOM) (S. Makita, T. Fabritius, and Y. Yasuno, “Full-range, high-speed, high-resolution 1-μm spectral-domain optical coherence tomography using BM-scan for volumetric imaging of the human posterior eye,” Opt. Express 16, 8406-8420 (2008)). In the present stage, we focus on the 2-D cross-sectional imaging via 1-D scanning. For further 3-D volumetric imaging, the 2-D scanning using a single magnetic actuator could be realized through the asymmetric cantilever approach (E. J. Min, J. G. Shin, Y. Kim, and B. H. Lee, “Two-dimensional scanning probe driven by a solenoid-based single actuator for optical coherence tomography,” Opt. Lett. 36, 1963-1965 (2011); T. Wu, Z. Ding, K. Wang, M. Chen, and C. Wang, “Two-dimensional scanning realized by an asymmetry fiber cantilever driven by single piezo bender actuator for optical coherence tomography,” Opt. Express 17, 13819-13829 (2009)).

### Image Processing

As shown in FIG. 29, within a single odd/even frame, a linear phase modulation φ(t|x)=β*(t|x) was applied to each M-scan/B-scan's 2D interferogram frame I(t|x,λ). Here t|x indicates time/position index of A-scans in each M-scan/B-scan frame. By applying Fourier transform along the t|x direction, the following equation can be obtained (Y. Yasuno, S. Makita, T. Endo, G. Aoki, M. Itoh, and T. Yatagai, “Simultaneous B-M-mode scanning method for real-time full-range Fourier domain optical coherence tomography,” Appl. Opt. 45, 1861-1865 (2006); S. Makita, T. Fabritius, and Y. Yasuno, “Full-range, high-speed, high-resolution 1-μm spectral-domain optical coherence tomography using BM-scan for volumetric imaging of the human posterior eye,” Opt. Express 16, 8406-8420 (2008)):

$${F}_{t \vert x \to f \vert u} [ I ( t \vert x , λ ) ] = {\vert {E}_{r} \vert}^{2} δ ( f \vert u ) + {Γ}_{f \vert u} \{ {F}_{t \vert x \to f \vert u} [ {E}_{s} ( t \vert x , λ ) ] \} + {F}_{t \vert x \to f \vert u} [ {E}_{r}^{*} ( t \vert x , λ ) {E}_{r} ( λ ) ] ⊗ δ ( f \vert u + β ) + {F}_{t \vert x \to f \vert u} [ {E}_{s} ( t \vert x , λ ) {E}_{r}^{*} ( λ ) ] ⊗ δ ( f \vert u - β ) , \qquad ( 5.2 )$$

where Eₛ (t|x,λ) and Eᵣ(λ) are the electric fields from the sample and reference arms, respectively. Γ_{f|u} { } is the correlation operator. The first three terms on the right hand of Eq. (5.2) present the DC noise, autocorrelation noise, and complex-conjugate noise, respectively. The last term can be filtered out by a proper band-pass filter in the f|u domain and then convert back to the t|x domain by applying an inverse Fourier transform along the f|u direction. The complete data processing can be divided into following steps:
(i) DC removal, and intensity compensation according to FIG. 31B;
(ii) Remapping the spectrum from λ domain to k domain;
(iii) Fourier transform along the t|x domain to the f|u domain;
(iv) Bandpass filter in the f|u domain by a super-Gaussian filter;
(v) Inverse Fourier transform along the f|u domain back to the t|x domain;
(vi) Numerical dispersion compensation by phase correction;
(vii) Fourier transform along the k domain to obtain depth information;
(viii) Correct the image distortion caused by the phase modulation; and
(ix) Correct the image distortion caused by the sinusoidal scanning.

In particular, here step (vi) is realized by adding a phase correction term Φ̅=−a₂(ω−ω₀)²−a₃(ω−ω₀)³ to the complex spectrum obtained after steps (iii) to (v) which serve as a modified Hilbert transform, where a₂ and a₃ are pre-optimized values according to the system properties (M. Wojtkowski, V. Srinivasan, T. Ko, J. Fujimoto, A. Kowalczyk, and J. Duker, “Ultrahigh-resolution, high-speed, Fourier domain optical coherence tomography and methods for dispersion compensation,” Opt. Express 12, 2404-2422 (2004)).

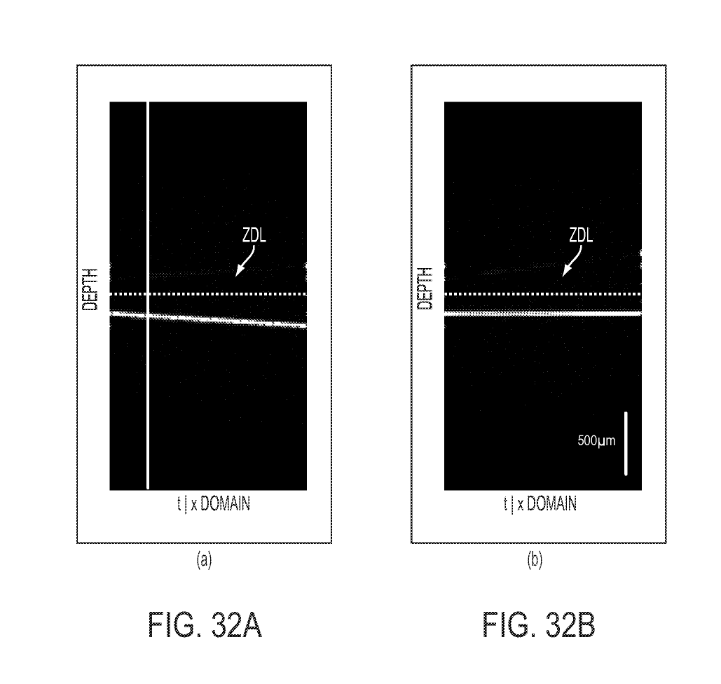

We then processed the M-scan data frame in FIG. 31A following steps (i) to (viii), and the results of the last two steps are shown in FIGS. 32A and 32B. Here step (ix) is not presented since no B-scan was conducted. As clearly shown in FIG. 32B, the complex-conjugate artifact was removed and the phase distortion by mirror displacement was also corrected, presenting a flat line in only one side of the zero-delay line (ZDL).

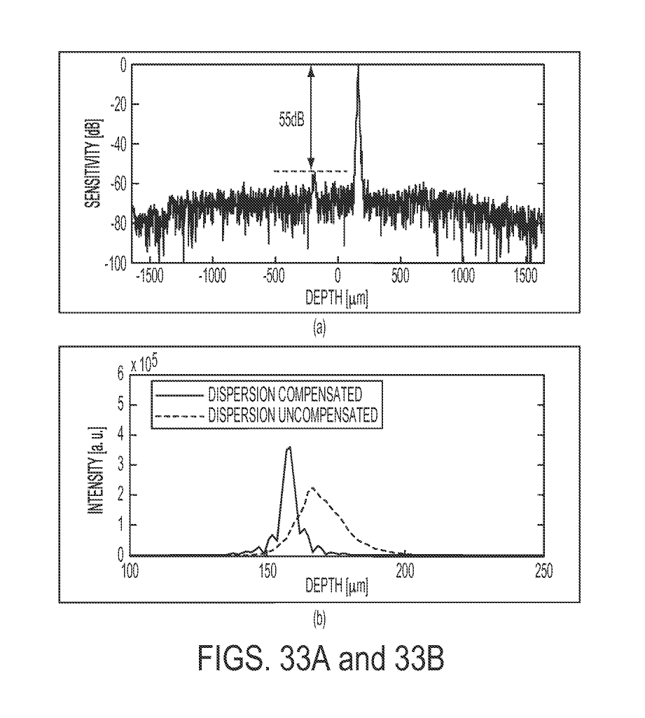

A single A-scan is extracted from the frame in FIG. 32A, as indicated by the vertical line, and shown in FIG. 33A. The complex-conjugate artifact suppression was better than 55 dB. FIG. 33B compares the dispersion compensated and uncompensated A-scan profiles. With the numerical dispersion compensation we have obtained a resolution (5.6 μm) very close to the pre-measured value (5.5 μm).

### Imaging Tests

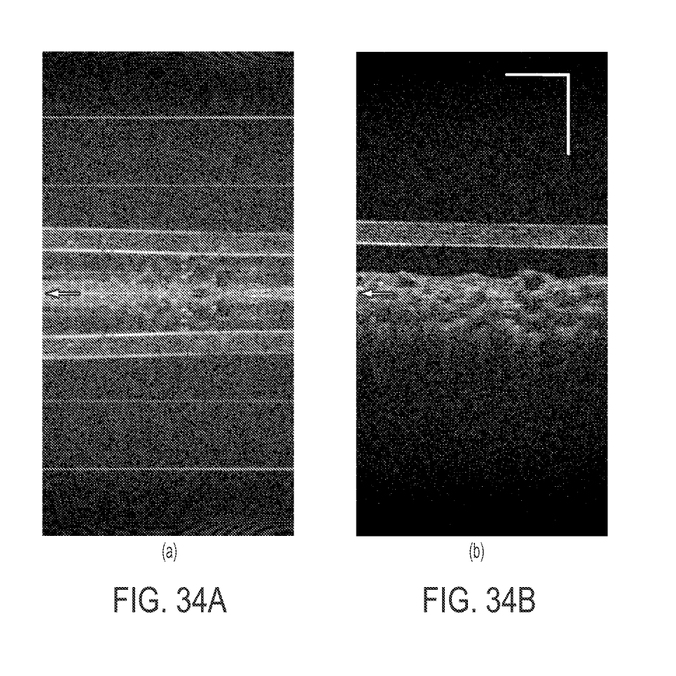

In the imaging test, the probe was operated under the single-direction scanning mode at 34 frame/s, and only the odd frames were acquired and processed with an image size of 1024 pixel lateral by 2048 pixel axial. FIGS. 34A and 34B show the image results of an IR card without and with the reference-arm phase modulation as a comparison. Under the phase modulation mode, the complex-conjugate artifact was effectively suppressed and the autocorrelation lines due to internal multiple reflection (the horizontal lines in FIG. 34A) were also eliminated.

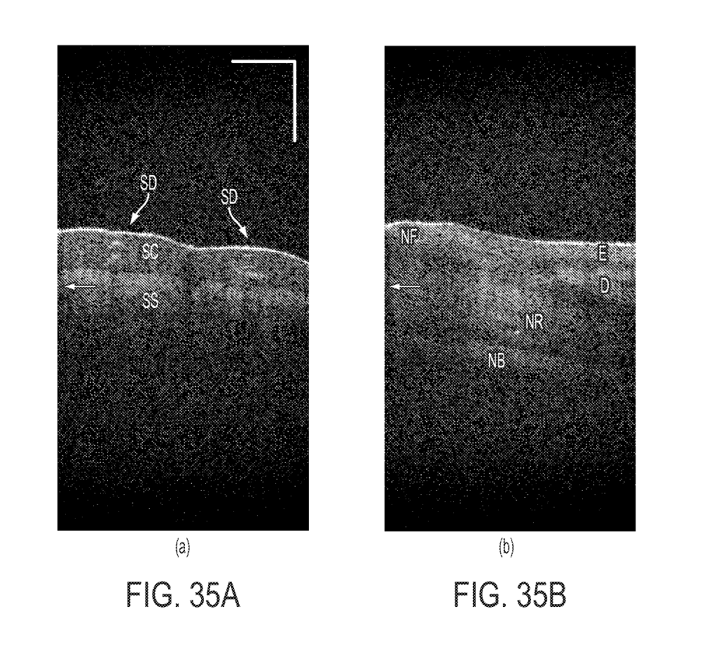

Finally, we conducted in vivo human finger imaging using the scanning probe with the same scanning protocol as depicted in FIG. 34B. FIG. 35A presents the coronal scans of the finger tip, where the epithelial structures such as stratum corneum (SC), stratum spinosum (SS) and sweat duct (SD) are clearly visible. FIG. 35B shows the sagittal scan of finger nail fold region, showing the major dermatologic structures such as epidermis (E), dermis (D), nail fold (NF), nail root (NR) and nail bed (NB).

### Conclusion and Discussion

In this example, a full-range FD-OCT imaging probe with a magnetic-driven resonant fiber cantilever was developed. The simultaneous B-M-mode phase modulation was implemented by scanning the reference mirror synchronized to the sample arm. The complete image processing was presented and in vivo human finger images were obtained with the complex-conjugate artifact removal. This method can also be generally applied to other types of FD-OCT imaging probes to eliminate the complex-conjugate artifact and double the imaging range.

### Example 6

### Numerical Dispersion Compensation

Optical dispersion mismatch is a common issue for all Michelson-type OCT systems, especially for an ultra-high resolution FD-OCT system using an extremely broadband light source. Therefore dispersion compensation is essential for such systems.

Hardware methods usually match the dispersion of the sample arms physically by putting dispersive optical components on the reference arm. One simple way is to use identical optical components. An alternative way is to use a dispersion matching prism pair. Both methods obviously cost extra and a perfect matching is usually difficult to realize in many cases especially when the dispersion mismatch is the result of the dispersion in the sample itself.

In comparison, numerical dispersion compensation is cost-effective and adaptable. Numerical dispersion compensation can be performed by adding a phase correction to the complex spectrum obtained via Hilbert transformation from the original spectrum (M. Wojtkowski, V. Srinivasan, T. Ko, J. G. Fujimoto, A. Kowalczyk, and J. Duker, “Ultrahigh-resolution, high-speed, Fourier domain optical coherence tomography and methods for dispersion compensation,” Opt. Express, vol. 12, pp. 2404-2422, 2004),

Φ̅=−a₂(ω−ω₀)²−a₃(ω−ω₀)³ (6.1)

where a₂ and a₃ can be pre-optimized values according to the system properties. In most cases, the majority of the dispersion mismatch comes from the optical system itself and the contribution from the image target is usually small. Even for retinal imaging with more than 20 mm of vitreous humor, the region of interest in the depth is usually within 1 mm, therefore in an ultrahigh speed imaging mode, a₂ and a₃ can be applied to all A-scans of the image frame or volume.

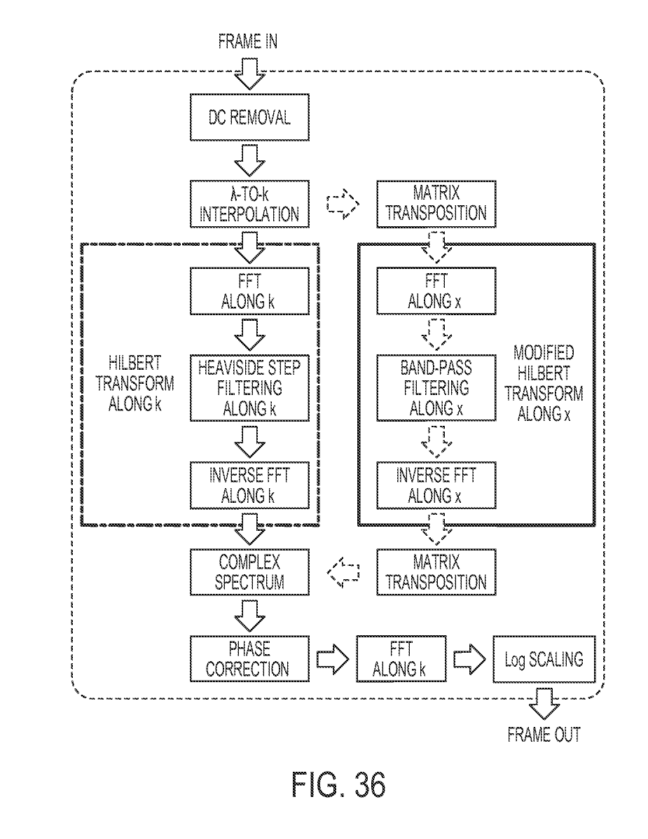

FIG. 36 illustrates GPU-accelerated numerical dispersion compensation according to an embodiment of the current invention. For the standard half-range FD-OCT, a Hilbert transform along the k domain can be realized by two FFTs and a Heaviside step filter. Here the dotted arrows indicate the path of the full-range FD-OCT processing, where the complex spectrum can be obtained by the modified Hilbert transform which also works as processing for the phase modulated frame (S. Makita, T. Fabritius, and Y. Yasuno, “Full-range, high-speed, high-resolution 1-μm spectral-domain optical coherence tomography using BM-scan for volumetric imaging of the human posterior eye,” Opt. Express, vol. 16, pp. 8406-8420, 2008).

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A real-time, three-dimensional optical coherence tomography system, comprising:
an optical interferometer configured to illuminate a target with light and to receive light returned from said target;
an optical detection system arranged in an optical path of light from said optical interferometer after being returned from said target, said optical detection system providing output data signals; and
a data processing system adapted to communicate with said optical detection system to receive said output data signals,
wherein said data processing system comprises a parallel processor configured to process said output data signals to provide real-time, three-dimensional optical coherence tomography images of said target.

2. A real-time, three-dimensional optical coherence tomography system according to claim 1, wherein said parallel processor is a graphics processing unit (GPU).

3. A real-time, three-dimensional optical coherence tomography system according to claim 2, wherein said optical detection system comprises a spectrometer to detect spectral components of light returned from said target, and
wherein said data processor is configured to process said output signals in a frequency domain such that said real-time optical coherence tomography system is a Fourier domain real-time optical coherence tomography system.

4. A real-time, three-dimensional optical coherence tomography system according to claim 3, wherein said GPU is configured to perform a wavelength to k-domain data conversion on said output signals.

5. A real-time, three-dimensional optical coherence tomography system according to claim 3, wherein said GPU is configured to perform a Fast Fourier Transform (FFT) on said output signals.

6. A real-time, three-dimensional optical coherence tomography system according to claim 5, wherein said FFT is a Non-Uniform Fast Fourier Transform (NUFFT).

7. A real-time, three-dimensional optical coherence tomography system according to claim 2, wherein said GPU is configured to perform computational dispersion compensation on said output signals.

8. A real-time, three-dimensional optical coherence tomography system according to claim 3, wherein said GPU is configured to perform a complex conjugate image filtering on said output signals.

9. A real-time, three-dimensional optical coherence tomography system according to claim 1, wherein said parallel processor comprises a first graphics processing unit (GPU1) configured to perform signal processing of said output signals and a second graphics processing unit (GPU2) configured to perform image rendering.

10. A real-time, three-dimensional optical coherence tomography system according to claim 9, wherein said image rendering comprises volume rendering.

11. A real-time, three-dimensional optical coherence tomography system according to claim 1, further comprising an endoscope,
wherein at least a portion of said optical interferometer is incorporated into said endoscope such that said real-time, three-dimensional optical coherence tomography system is configured for endoscopic imaging.

12. A real-time, three-dimensional optical coherence tomography system according to claim 1, further comprising a measurement beam scanning system configured to scan illumination light from said optical interferometer across said target.

13. A real-time, three-dimensional optical coherence tomography system according to claim 12, wherein said optical interferometer has a reference leg comprising a reference mirror.

14. A real-time, three-dimensional optical coherence tomography system according to claim 13, further comprising a modulation system connected to said reference mirror to modulate motion of said reference mirror.

15. A real-time, three-dimensional optical coherence tomography system according to claim 14, wherein said scanning system and said modulation system are mode-locked systems.

16. A real-time, three-dimensional optical coherence tomography system according to claim 1, wherein said optical interferometer is a common path optical interferometer.
